(19) United States
(12) Patent Application Publication
(10) Pub. No.: US 2024/0260500 A1
(43) Pub. Date: Aug. 8, 2024

(54) ALL ELECTRICAL PLANTER AND ELECTRICAL PLANTER COMPONENTS

(71) Applicant: Kinze Manufacturing, Inc., Williamsburg, IA (US)

(72) Inventors: Matthew Wilhelmi, Williamsburg, IA (US); Phil Jennings, Williamsburg, IA (US); Philip Willis, Williamsburg, IA (US); Gary Newell, Williamsburg, IA (US); Steve Nolte, Williamsburg, IA (US); Jamie Shults, Williamsburg, IA (US); Jay Grimes, Williamsburg, IA (US)

(21) Appl. No.: 18/436,763

(22) Filed: Feb. 8, 2024

Related U.S. Application Data
(60) Provisional application No. 63/483,858, filed on Feb. 8, 2023.

(51) Int. Cl. A01B 79/00; A01B 76/00; A01C 19/02; H02P 9/02

(52) U.S. Cl. CPC A01B 79/005; A01B 76/00; A01C 19/02; H02P 9/02

(57) ABSTRACT

An electrically operated agricultural planting implement is used with an agricultural vehicle. The planting implement may include a generator to generate electric power to power electronic components located on the row units of the planting implement as well as to power other functionality of the planting implement such as lifting and/or pivoting. Operating the planting implement via electric power rather than hydraulic power eliminates the need for hydraulic plumbing. A wireless data communication and control system is used with an agricultural planting implement and an agricultural vehicle. The system provides for bidirectional data communication and control between a control unit and the planting implement. The system eliminates the need for wiring and also provides the ability to communicate with and control the planting implement remotely. A user can wirelessly and remotely control the planting implement by inputting commands into the control unit.

### CROSS REFERENCE TO RELATED APPLICATIONS

This application claims priority under 35 U.S.C. § 119 to provisional patent application U.S. Ser. No. 63/483,858, filed Feb. 8, 2023. The provisional patent application is herein incorporated by reference in its entirety, including without limitation, the specification, claims, and abstract, as well as any figures, tables, appendices, or drawings thereof.

### FIELD OF THE INVENTION

Aspects and/or embodiments of the present disclosure relate generally to apparatuses, systems, and/or corresponding methods of use and/or manufacture having applications in at least the agriculture industry. More particularly, but not exclusively, aspects and/or embodiments of the present disclosure relate to an all electrical agricultural planting implement and components for a planting implement for planting an agricultural field. Even more particularly, but not exclusively, the components for a planting implement comprise at least a data communication and control system for use with an agricultural implement.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

The agriculture industry is more important than ever due to the need to feed the world's growing population. At the same time, as the world's population increases and resources become scarcer, resource conservation is becoming critical. Thus, it is important to improve the efficiency and ease of farming such that more food can be produced with less effort, time, cost, and resources.

Existing agricultural planting implements that include electric power only use electric power for particular functions of the planter. Existing agricultural planting implements that claim to be electrically driven still include the use of hydraulic power for some functions of the planting implement and, thus, are not completely electrical. Therefore, existing planting implements that claim to be electrically driven still use hydraulic hoses and other items necessary for hydraulic plumbing such as valves, fittings, hydraulic radiators, and the like. Incorporating hydraulic plumbing on a planting implement can lead to many issues including valve/hose blockages, cut/damaged hoses, leaks, blocks sticking, and the like. Resolving these types of issues takes time, effort, and money on the part of the farmer for repairs, maintenance, and/or replacement parts. Also, the use of hydraulic plumbing with an agricultural implement can create issues regarding valve requirements to connect the hydraulic plumbing to the power take-off (PTO) of the agricultural vehicle. Further, use of hydraulic plumbing/hydraulic operation causes heat buildup via the hydraulic radiators, which causes energy loss. The use of hydraulic plumbing/hydraulic operation causes the agricultural vehicle to use fuel at a relatively high rate. The use of hydraulic plumbing also renders it difficult and time consuming to swap out a row unit of an agricultural implement if necessary and can hinder the ability of the implement to be modular in that the row units do not operate on a plug-and-play basis. Swapping out a row unit with a planter that uses hydraulic power involves disconnecting/reconnecting several aspects of the hydraulic plumbing including at least, hoses, valves fittings, hydraulic radiators, and the like. Additionally, some existing agricultural planting implements use pneumatic systems to power at least some aspects of the implement, such as down force. Such pneumatic systems, and components thereof such as hoses, valves, fittings, and the like, degrade and/or deteriorate over time wherein leaks often occur, which renders the systems ineffective. It takes time, effort, and money on the part of a farmer to monitor, maintain, repair, replace, and/or resolve issues related to degraded, deteriorated, and/or leaky components of a pneumatic system.

Thus, there exists a need in the art for an all electrical agricultural planting implement that eliminates the use of hydraulic operation, hydraulic power, and/or hydraulic plumbing. There also exists a need in the art for an all electrical agricultural planting implement that eliminates the need for pneumatic systems used for at least some aspects of the implement, such as down force.

Some existing data communication and control systems for use with an agricultural planting implement lack true bidirectional data communication and control. Additionally, some existing communication/control systems use wiring between an agricultural vehicle and an agricultural implement. This type of wiring/data cables is subject to sustain damage and general wear and tear related to stretching, flexing, and other types of movement that will occur due to movement, lifting, pivoting, and the like performed by the agricultural planting implement and/or agricultural vehicle. The use of wires can also cause issues related to improper wire routing, which can occur upon initial installation as well as when any wires are repaired, replaced, and/or otherwise fixed. Thus, the use of physical wiring, as is common in the prior art, costs a user/operator valuable time, effort, and money to complete any repairs, maintenance, replacements, and/or otherwise fix the wiring. Cables can be costly, often ranging from $2,000.00 to $4,000.00. Additionally, some existing communication/control systems used to communicate with and/or control an agricultural planting implement are permanently mounted in and/or on an attached agricultural vehicle. Thus, a user/operator cannot remotely communicate with and/or control the agricultural planting implement. This lack of remote communication/control costs a user valuable time and effort.

There further exists a need in the art for an apparatus, method, and/or system which has the ability to provide bidirectional data communication and control between a control unit and an agricultural planting implement wherein the system is wireless and has remote capabilities.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of at least some of the aspects and/or embodiments disclosed to improve on or overcome the deficiencies in the art.

It is a further object, feature, and/or advantage of at least some of the aspects and/or embodiments disclosed to provide a planting implement and/or system that is fully electrically operated such that it eliminates the need for any kind of hydraulic operation, hydraulic power, and/or hydraulic plumbing.

It is a further object, feature, and/or advantage of at least some of the aspects and/or embodiments disclosed to provide a planting implement, method, and/or system that eliminates the need for hydraulic hoses and other items used for hydraulic plumbing including fittings, valves, hydraulic radiators, and the like. Thereby, the planting implement, method, and/or system eliminates the effort, time, and money needed to monitor, maintain, repair, replace, and/or resolve issues (e.g., hose blockage) related to these items used for hydraulic plumbing.

It is a further object, feature, and/or advantage of at least some of the aspects and/or embodiments disclosed to provide a planting implement, method, and/or system that eliminates the need to fulfill valve requirements to connect hydraulic plumbing to the power take-off of an attached agricultural vehicle.

It is a further object, feature, and/or advantage of at least some of the aspects and/or embodiments disclosed to provide a planting implement, method, and/or apparatus that provides the ability to improve efficiency and resource conservation by increasing the fuel efficiency of an attached agricultural vehicle and mitigating energy loss that exists in the prior art due to heat buildup caused by hydraulic radiators during normal hydraulic operation.

It is a further object, feature, and/or advantage of at least some of the aspects and/or embodiments disclosed to provide an apparatus, method, and/or system that allows for row units of an agricultural implement to be modular in that they can operate on a plug-and-play basis.

It is still yet a further object, feature, and/or advantage of at least some of the aspects and/or embodiments disclosed to provide an apparatus, method, and/or system wherein row units of an agricultural implement are able to be swapped out quickly and easily in order to minimize downtime.

It is a further object, feature, and/or advantage of at least some of the aspects and/or embodiments disclosed to provide a planting implement, method, and/or system that eliminates the need for pneumatic systems for some implement functionality such as downforce. Thereby, the planting implement, method, and/or system eliminates the time, effort, and money needed to monitor, maintain, repair, replace, and/or resolve issues related to components of a pneumatic system, which are prone to degrade, deteriorate, and/or leak.

It is a further object, feature, and/or advantage of at least some of the aspects and/or embodiments disclosed to provide an apparatus, system, and/or method that provides bidirectional data communication and control between a control unit and an agricultural planting implement wherein the apparatus, method, and/or system is wireless and has remote capabilities.

It is a further object, feature, and/or advantage of at least some of the aspects and/or embodiments disclosed to provide an apparatus, method, and/or system that eliminates the need for physical wiring such that a user/operator does not have to spend valuable time, effort, and/or money to monitor, maintain, repair, replace, and/or fix such wiring.

It is still yet a further object, feature, and/or advantage of at least some of the aspects and/or embodiments disclosed to provide an apparatus, method, and/or system that allows for a user/operator to communicate with and/or control the agricultural planting implement remotely such that the user/operator can save valuable time and effort without needing to be in, on, at, and/or near the agricultural implement and/or agricultural vehicle in order to communicate with and/or control the agricultural implement.

The apparatus(es), method(s), and/or system(s) disclosed herein can be used in a wide variety of applications. For example, while the apparatus(es), method(s), and/or system(s) are typically associated with an agricultural planting implement and/or agricultural vehicle, the apparatus(es), method(s), and/or system(s) disclosed herein could be used in a variety of agricultural operations including but not limited to planting, fertilizing, spraying, tilling, discing, and the like.

It is preferred the apparatus(es), method(s), and/or system(s) practice resource conservation and are safe, cost effective, durable, and environmentally friendly. For example, some of the advantages of the present apparatus(es), method(s), and/or system(s) disclosed herein include eliminating the need for hydraulic operation and hydraulic plumbing. Thus, none of the items used for hydraulic plumbing (e.g., hoses, fittings, valves, hydraulic radiators, etc.) are included and/or needed by the apparatus(es), method(s), and/or system(s) disclosed herein. Additionally, the apparatus(es), method(s), and/or system(s) disclosed herein provide for increased fuel efficiency and mitigation of energy loss. Further, the apparatus(es), method(s), and/or system(s) disclosed herein provide for the elimination of physical wiring.

Methods can be practiced which facilitate use, manufacture, assembly, maintenance, and/or repair of an apparatus and/or system which accomplishes some or all of the previously stated objectives.

The apparatus and/or system can be incorporated into larger designs which accomplish some or all of the previously stated objectives.

According to some aspects of the present disclosure, an electrically operated agricultural planting implement, comprises one or more electronic components associated with the implement and configured to perform at least one agricultural function; a generator to generate electric power and supply said electric power to the one or more electronic components; wherein the electric power is used to power the one or more electronic components, and the implement and components are operated without the need for hydraulic connection between the implement and a tow vehicle.

According to at least some aspects of some embodiments disclosed, the electrically operated agricultural planting implement further comprises one or more row units that each comprises an electronic seed metering system for metering and delivering seed to the ground.

According to at least some aspects of some embodiments disclosed, the electrically operated agricultural planting implement further comprises an electrical distribution box to receive the electric power generated by the generator.

According to at least some aspects of some embodiments disclosed, the generator is operatively connected to and driven by a power take-off of the agricultural vehicle.

According to at least some aspects of some embodiments disclosed, the generator is configured to provide voltage conversion to step up and/or step down a voltage level provided by the power take-off of the agricultural vehicle.

According to at least some aspects of some embodiments disclosed, the electrically operated agricultural planting implement further comprises a toolbar wherein the toolbar comprises a busbar.

According to at least some aspects of some embodiments disclosed, each of the one or more electronic components comprises a conductive portion and is operatively connected to the busbar via the conductive portion each of the one or more electronic components comprises a conductive portion and is operatively connected to the busbar via the conductive portion.

According to at least some aspects of some embodiments disclosed, a portion of the toolbar further comprises a row unit and the one or more electronic components comprise at least one electrically driven element located on the row unit.

According to at least some aspects of some embodiments disclosed, a portion of the toolbar comprises a conductor wherein the row unit comprises a conductive portion for contacting the conductor of the toolbar.

According to at least some aspects of some embodiments disclosed, the electrically operated agricultural planting implement further comprises a securing mechanism to hold the row unit in place and in contact with the toolbar to conduct the electric power from the toolbar to the row unit.

According to at least some aspects of some embodiments disclosed, the one or more row units are modular, and each comprises at least one electrically driven element such that the at least one electrically driven element thereon can be controlled independently of other electrically driven elements, other electronic components, and/or other row units.

According to at least some aspects of some embodiments disclosed, a data communication and control system for use with an agricultural planting implement and an agricultural vehicle, comprises one or more electronic components configured to perform at least one agricultural function; and a control unit configured to allow for bidirectional data communication and control between the control unit and the agricultural planting implement; wherein the data communication and control between the control unit and the agricultural planting implement is performed via a wireless connection; and wherein the control unit is capable of being remote from the agricultural planting implement and the agricultural vehicle such that it is not mounted on the agricultural implement or the agricultural vehicle.

According to at least some aspects of some embodiments disclosed, the control unit comprises a two-way data transmitter/receiver component to enable the bidirectional data communication and control.

According to at least some aspects of some embodiments disclosed, the wireless connection is a WiFi connection.

According to at least some aspects of some embodiments disclosed, the wireless connection is a cellular connection.

According to at least some aspects of some embodiments disclosed, linked data is integrated into the cellular connection.

According to at least some aspects of some embodiments disclosed, the control unit comprises a user interface such that the user can control/operate aspects of the agricultural planting implement by providing input to the control unit, and wherein the control unit provides output such that the user can view and interpret said output.

According to at least some aspects of some embodiments disclosed, the control unit comprises one or more control units wherein the one or more control units are mobile devices such that the user can remotely control/operate the agricultural planting implement via the one or more control units.

According to at least some aspects of some embodiments disclosed, the system provides machine health/status monitoring and/or allows for diagnosis of machine health conditions.

According to at least some aspects of some embodiments disclosed, the machine health/status information and/or the diagnosis of machine health conditions is viewable on a virtual monitor wherein a user does not have access to functionality of the agricultural planting implement.

According to at least some aspects of some embodiments disclosed, an agricultural system for use with an agricultural planting implement and an agricultural vehicle, comprises: one or more row units located on the agricultural planting implement wherein each of the one or more row units comprises one or more electrically driven elements configured to perform at least one agricultural function; a generator to generate electric power and supply said electric power to the agricultural planting implement; wherein the electric power is used to power the one or more electrically driven elements and the implement and elements are operated without the need for hydraulic connection between the implement and a tow vehicle.

According to at least some aspects of some embodiments disclosed, a method of supplying power to an agricultural planting implement, comprises: generating electric power via a generator; supplying the electric power to the agricultural planting implement wherein the agricultural planting implement comprises one or more electronic components; wherein the electric power is used to power the one or more electronic components and the implement and components are operated without the need for hydraulic plumbing between the implement and a tow vehicle.

According to at least some aspects of some embodiments disclosed, the method further comprises stepping down and/or stepping up the voltage level of the electric power before supplying the electric power to the one or more electronic components.

According to at least some aspects of some embodiments disclosed, the agricultural planting implement comprises a toolbar and the toolbar comprises a busbar.

According to at least some aspects of some embodiments disclosed, the method further comprises securing a row unit to the toolbar via a securing mechanism wherein a conductive portion of the row unit is in contact with the busbar and/or a conductor of the busbar.

According to at least some aspects of some embodiments disclosed, supplying the electric power to the one or more electronic components comprises operationally connecting the one or more electronic components to the busbar.

According to at least some aspects of some embodiments disclosed, the power source to the generator is a power take-off of the tow vehicle.

According to at least some aspects of some embodiments disclosed, the agricultural planting implement comprises one or more row units that are modular and wherein each of the one or more row units comprises at least one electrically driven element such that the at least one electrically driven element can be controlled independently of other electrically driven elements, other electronic components, and/or other row units.

According to at least some aspects of some embodiments disclosed, a method of communicating data and controlling functionality associated with agricultural planting for use with an agricultural planting implement and an agricultural vehicle, comprising: wirelessly connecting a control unit and one or more electronic components wherein each of the one or more electronic components is located on the agricultural planting implement; wherein the wireless connection between the one or more electronic components and the control unit allows for bidirectional data communication and control; and wherein the control unit is capable of being remote from the agricultural planting implement and the agricultural vehicle such that it is not mounted on the agricultural planting implement or the agricultural vehicle.

According to at least some aspects of some embodiments disclosed, the control unit comprises a user interface such that a user can control/operate aspects of the agricultural planting implement by providing input to the control unit, and wherein the control unit provides output such that the user can view and interpret said output.

According to at least some aspects of some embodiments disclosed, the control unit comprises one or more control units wherein the one or more control units are mobile devices such that the user can remotely control/operate the agricultural planting implement via the one or more control units.

According to at least some aspects of some embodiments disclosed, the method further comprises outputting machine health/status monitoring and/or allows for diagnosis of machine health conditions via the user interface.

According to at least some aspects of some embodiments disclosed, the method further comprises outputting machine health/status information and/or diagnosis of machine health conditions on a virtual monitor accessible on a device other than the control unit.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

FIG. 1 is an elevation view of an agricultural vehicle.

FIG. 2 is a top plan view of an agricultural planting implement according to at least some aspects and/or embodiments of the present disclosure.

FIG. 3 is a schematic showing exemplary components for an agricultural implement and/or row units of an agricultural implement according to some aspects and/or embodiments of the present disclosure.

FIG. 4 is a block diagram of an example embodiment of a busbar and/or toolbar as well as other aspects of the agricultural planting implement shown in FIG. 2.

FIG. 5 is a perspective view of a row unit to be used with an agricultural implement, such as disclosed herein.

FIG. 6 is a side elevation view of the row unit of FIG. 5.

FIG. 7 is a block diagram of a communication/control system according to at least some aspects and/or embodiments of the present disclosure.

An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

The present disclosure is not to be limited to that described herein. Mechanical, electrical, chemical, procedural, and/or other changes can be made without departing from the spirit and scope of the present invention. No features shown or described are essential to permit basic operation of the present invention unless otherwise indicated.

Unless defined otherwise, all technical and scientific terms used above have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

The term “agricultural equipment” encompasses any type of machinery and/or device(s) associated with the agriculture industry. For example, both agricultural vehicles and agricultural implements are encompassed by the term “agricultural equipment”.

The terms “agricultural planting implement”, “planting implement”, and “planter”, can be used interchangeably herein.

The term “particulate material” shall be construed to have a broad meaning, and includes, but is not limited to grain, seed, fertilizer, insecticide, dust, pollen, rock, gravel, dirt, stock, or some combination thereof. Particulate material can be mixed with air to form airborne matter.

As used herein, the term “exemplary” refers to an example, an instance, or an illustration, and does not indicate a most preferred embodiment unless otherwise stated.

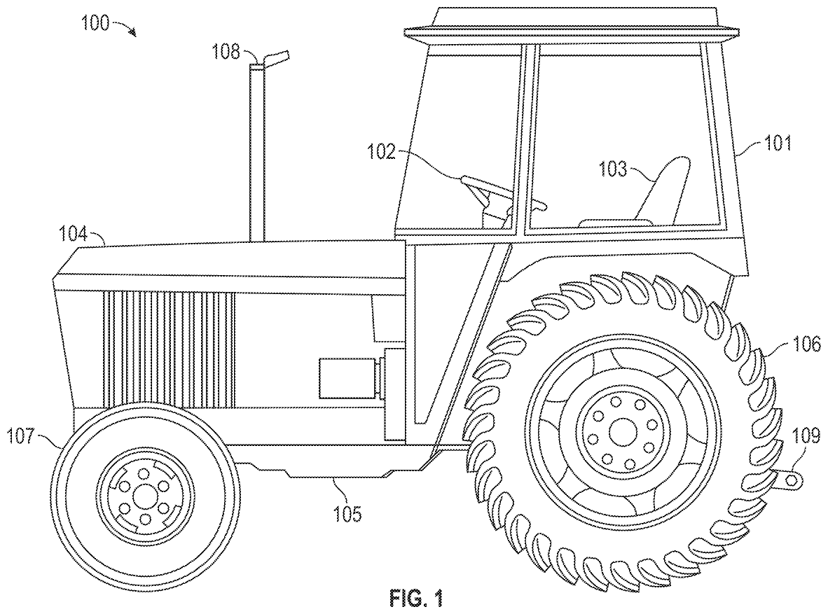

FIG. 1 discloses an agricultural vehicle 100 (e.g., a tractor) used for the purposes of towing machinery used in agriculture (e.g., agricultural implements) or otherwise performing agricultural operations. The vehicle 100 may be referred to as a prime mover, tow vehicle, or the like. The agricultural vehicle 100 may be used to tow an agricultural implement, such a planter, seeder, sprayer, tiller, plow, baler, grain cart, or any other implement used in agriculture. The agricultural vehicle 100 may include a cab 101 with a steering wheel 102 and a seat 103 for an operator. The agricultural vehicle 100 may also include a vehicle frame 104 which houses an engine located near the front axle of the agricultural vehicle 100 and in front of the cab 101. The cab 101 and vehicle frame 104 may be supported, structurally, by the agricultural vehicle's chassis 105, which attaches to rear drivable wheels 106 and front steerable wheels 107, said front steerable wheels 107 operationally connected to the steering wheel 102. An exhaust pipe 108 allows carbon monoxide to exit the agricultural vehicle 100 during operation of the engine. A vehicle hitch 109 allows for connection between agricultural machinery, such as agricultural implements, and the agricultural vehicle 100.

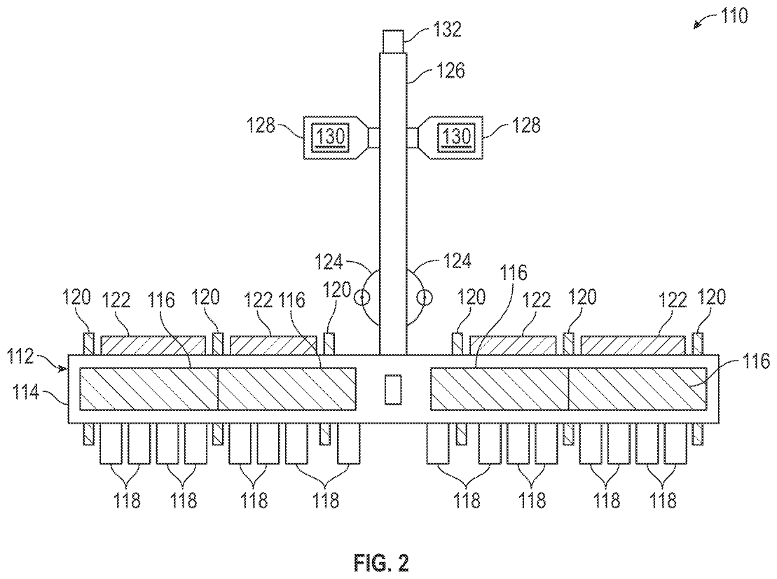

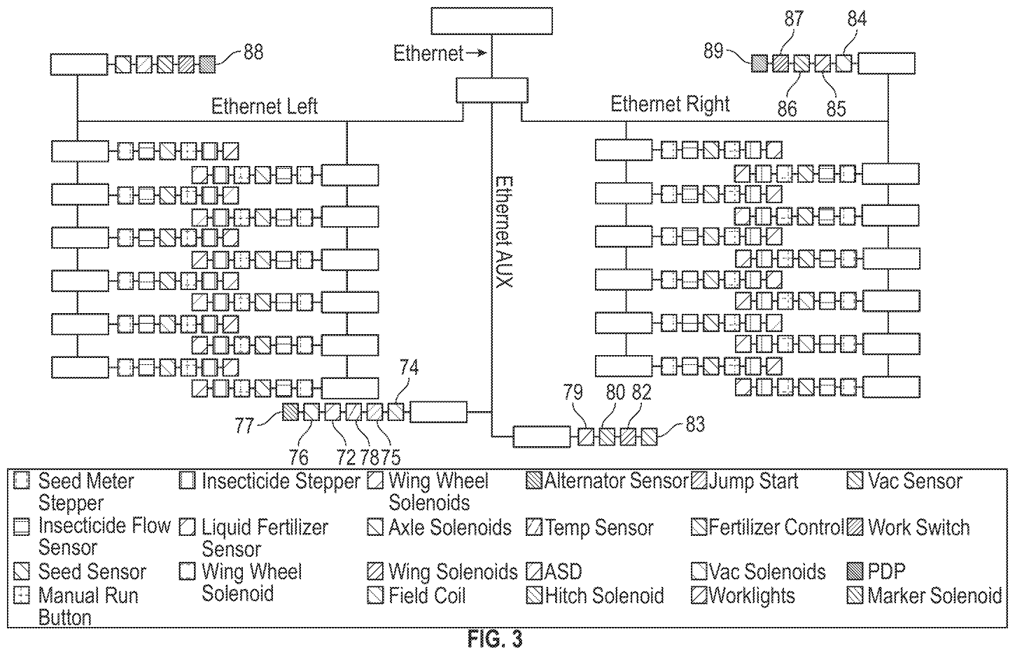

FIG. 2 discloses an agricultural planting implement 110 according to and/or including various aspects and/or embodiments that will be understood to include improvements over the known art. The agricultural planting implement 110 shown is an all electrical implement. It should be understood that the term all electrical, according to at least some aspects of some embodiments disclosed, is meant to state that the components connected to or on the planter are operated using electrical power, as opposed to hydraulic power and/or pneumatic power, which have traditionally been used. However, it should also be understood that, while the electricity is providing power to the components, the components themselves may include subcomponents that can include hydraulics, pneumatics, or the like. For example, an electro-hydraulic actuator uses electricity to operate a pump on the actuator to move the hydraulic fluid. Thus, while hydraulic fluid is used to move the actuator rod, this is powered by electricity. As another example, seed meter(s) can be included on the implement wherein the seed meter(s) are electrically powered but the meter(s) include pneumatic aspect(s) such as a vacuum. In addition, while not limiting, such components commonly found on agricultural equipment that can be operated electronically can include, actuators, fans, pumps, sensors, motors, other controls, lights, switches, etc. For example, FIG. 3 is a schematic of some aspects of the implement 110 according to some embodiments that shows examples of components that can be included as part of the implement 110 or row units 118 thereon, wherein the components shown in FIG. 3 can each be operated electronically. While the components shown in FIG. 3 provide examples of electrically operated components that can be included on the implement 110 and/or row units 118 thereof, any suitable electrically operated component could be included. FIG. 3 includes, on the row unit(s) 118 or elsewhere on the implement 110, seed meter stepper(s)/motor(s), insecticide flow sensor(s), seed sensor(s), manual run button(s), insecticide stepper(s)/motor(s), liquid fertilizer sensor(s), wing wheel solenoid(s) 72, axle solenoid(s) 74, wing solenoid(s) 75, field coil(s) 76, alternator sensor(s) 77, temperature sensor(s) 78, air seed delivery control(s) 79, hitch solenoid(s) 80, jump start control(s) 82, fertilize control(s) 83, vacuum solenoid(s) 84, worklight(s) 85, vacuum sensor(s) 86, word switch(es) 87, PDP 88, and/or marker solenoid(s) 89. While the all electrical implement 110 can operate via wireless data communication/control according to some embodiments, the implement 110 can use Ethernet for data communication/control of at least some aspects of the implement 110 according to at least some embodiments. According to some embodiments, each string of components shown in FIG. 3 can be a row unit 118 of the implement 110 and/or can be another aspect of the implement 110. For example, according to some embodiments, a seed meter stepper/motor, insecticide flow sensor, seed sensor, manual run button, insecticide stepper/motor, and liquid fertilizer sensor could be located on a row unit 118. However, such components could be located anywhere on the implement 110.

The agricultural planting implement 110 can include a toolbar 112 wherein the toolbar 112 is and/or includes a busbar 114. The agricultural planting implement 110 can further include zero or more seed tanks 116, zero or more row units 118, zero or more tracks 120, zero or more fertilizer tanks 122, zero or more transport wheels 124, a tongue 126, zero or more spaces for an electric power generator 128, zero or more electric power generators 130, and/or a hitch 132.

The planting implement 110 as shown in the FIG. 2 includes a tongue 126 with a hitch 132 at a first end and a toolbar 112 extending generally transversely to the tongue 126 at a second end. The toolbar 112 extends to connect to a plurality of row units 118, which include ground engagement apparatus. Each of the row units 118 may also include additional aspects such as meter(s), metering element(s), singulation element(s), fertilizer equipment, seed tank(s)/hopper(s), sensor(s), ground engaging apparatus(es), ground opening and/or closing element(s), metering system, seed delivery system, motor(s), fan(s), belt(s), actuator(s), wheel(s), and the like wherein each aspect can be electrically operated according to some embodiments. Herein, these aspects can be referred to as electrically driven elements. It is to be appreciated that generally other types of row units, ground engaging elements, and/or metering elements can utilize any of the aspects and/or embodiments disclosed herein. For example, the row units 118 could include fertilizer or other particulate and/or liquid material application apparatus, and the entrainment system disclosed be used to distribute the particulate and/or liquid material to the row units 118.

The toolbar 112 can include wing elements that extend outwardly from the toolbar 112 and are generally an extension thereof. The wing elements provide additional width of the toolbar such that additional row units 118 can be attached along thereto. This allows for a greater number of row units 118 to be attached to the toolbar 112 to be used for an agricultural function including but not limited to planting and/or distributing a particulate material and/or liquid fertilizer. The planting implement 110 can further include draft links which generally connect the wing elements to the tongue 126. One or more actuators can be included as part of the planting implement 110 and/or system thereof to provide for the wing elements to be folded in a generally forward manner wherein they will be somewhat parallel to the tongue 126 to move the planting implement 110 from a field use configuration to a row use configuration. Such actuators can be electrically operated according to some embodiments. Such actuators can also be used to provide a downforce on the wings. Additional planting units may include that the toolbar 112 is lifted and rotated, is folded rearwardly, is folded vertically, does not fold at all, or includes some sort of combination thereof.

Agricultural planting implements, such as the example implement 110 shown in FIG. 2, are used to distribute, meter, and place particulate materials, such as seed, in operable and/or desired locations in a field. This is based, in part, on agronomical data, which is used to determine the optimal spacing, depth, and location of seed to give the seed the best chance to mature into a crop with the best possible yield. In some embodiments, the agricultural implement 110 of FIG. 2 can include central hoppers, wherein the central hoppers may store particulate materials, such as seed, and/or liquid materials, such as liquid fertilizer, to be applied to an agricultural field. The example agricultural implement 110 of FIG. 2 may also apply liquid material, such as liquid fertilizer, to an agricultural field.

To further aid in increasing the performance and growing of crop from a planted seed, implements can include systems and other apparatus that are used to apply, place, or otherwise dispense a fertilizer, such as a liquid or dry fertilizer material. For agricultural planting implements, a fertilizer applicator/distribution system, such as the system disclosed in U.S. Patent Application No. 63/261,973, filed Oct. 1, 2021, which is hereby incorporated in its entirety, can be included with the row units of the planter, or with the implement as a whole. This will provide the application of the fertilizer contemporaneously, or near-contemporaneously, with the planting of the seed. However, it should be appreciated that, if the implement is an applicator only, such as a sprayer, the system can continually provide needed liquid fertilizer on an as-needed basis. The system can include one or more hoppers/tanks, either at a bulk hopper site, at the individual row units, or split out to cover regions or sections of row units, wherein the application sites will be fed an amount of the liquid fertilizer. The system, and components thereof, can be electrically operated according to some embodiments.

The toolbar 112 of the example embodiment of agricultural planting implement 110 shown in FIG. 2 can be and/or can comprise a busbar 114. In electric power distribution, a busbar (also bus bar) is a metallic strip or bar, typically housed inside switchgear, panel boards, and busway enclosures for local high current power distribution. They are also used to connect high voltage equipment at electrical switchyards, and low voltage equipment in battery banks. Distribution boards split the electrical supply into separate circuits at one location. Busways, or bus ducts, are long busbars with protective covers. Rather than branching from the main supply at one location, they allow new circuits to branch off anywhere along the busway. Busbars may be connected to each other and to electrical apparatus by bolting, clamping or welding. The busbar 114 can be used for power distribution. The busbar 114 can be any suitable shape including but not limited to a flat strip, a solid bar, a rod, or the like. Still further, the busbar 114 be a connection point on the toolbar to allow for electrical connection thereto.

The busbar 114 can be constructed of any suitable conductive material including but not limited to copper, brass, aluminum, and the like. The busbar 114 can extend along the toolbar 112 and be generally the same length, width, and/or height of the toolbar 112. In some embodiments, the busbar 114 can have a different length, width, and/or height than the toolbar 112. In some embodiments, the toolbar 112 is the busbar 114. According to some embodiments, on-row hoppers/tanks can be included to increase the weight of the busbar 114 and/or toolbar 112. Electronic components 123 on the implement 110 can be operationally connected to the busbar 114 and/or toolbar 112 to receive electric power from the busbar 114 and/or toolbar 110. Electronic components 123 can include can include any other electronic aspect of the agricultural planting implement 110 including but not limited to actuators; tanks; hoppers; fans; equipment associated with folding, lifting, tilting, rotating, pivoting, and/or other movements of the implement such as actuators; row units 118 and any electrically driven element 119 of the row unit such as meter(s), metering elements, singulation elements, fertilizer equipment, other particulate and/or liquid material application apparatus seed tank(s)/hopper(s), sensor(s), ground engaging apparatus, ground opening and/or closing elements, metering system, sensors, motors and the like. Each row unit 118, and each of the one or more electrically driven elements 119 thereon that are configured to perform at least one agricultural function, can be operationally connected to the busbar 114 and/or toolbar 112 in order to receive power from the busbar 114 and/or toolbar 112. In some embodiments, the busbar 114 can be a 400 V bus. However, the busbar 114 can be any suitable voltage level.

The busbar 114 and/or toolbar 112 can be used to distribute power to the electronic components 123 of the implement 110 including row units 118 and electrically driven elements 119 located on the row units 118. In some embodiments, the row units 118, and/or electrically driven elements 119 thereon, can be mounted and/or otherwise operationally connected to the busbar 114 and/or toolbar 112 to complete a circuit such that the row units 118, and/or electrically driven elements 119 thereon, receive power and are operational. According to some embodiments, the busbar 114 and/or toolbar 112 can be adapted so that it has proper and/or even weight distribution such that the busbar 114 and/or toolbar 112 is stable, does not inadvertently tip or lean, and provides the proper amount of down force when performing an agricultural function such as planting, fertilizing, spraying, tilling, discing, and the like.

Each row unit 118, and/or electrically driven elements 119 thereon, can include a conductive portion 121 such that the conductive portion 121 can contact at least a portion of the busbar 114 and/or toolbar 112 wherein the row unit 118 and electrically driven elements 119 thereon are operationally connected to the busbar 114 and/or toolbar 112 and can receive power from the busbar 114 and/or toolbar 112. The conductive portion 121 can be made of any kind of conductive material(s) including but not limited to copper, brass, aluminum, and the like. The conductive portion 121 can take any suitable shape and/or form. For example, the conductive portion 121 could be a wire, a cable, a rivet, any kind of connector such as a clamp, the face plate 144 of the row unit 118, linkage(s) 146 of the row unit 118, a portion of the frame 148 of the row unit 118, a mount (such as a U-bolt mount) of the row unit 118, and/or any other suitable component including but not limited to any other portion of the row unit 118. Additionally, according to some embodiments, the implement 110 can include zero or more securing mechanisms 125 to hold each row unit 118 in place such that it is in contact with the busbar 114 and/or toolbar 112 wherein the row unit 118, and electrically driven elements 119 thereon, can receive electrical power from the busbar 114 and/or toolbar 112. The securing mechanism 125 can be easily connected to and/or disconnected from the busbar 114, toolbar 112, and/or a row unit 118 such that a row unit 118 can be easily swapped out. The securing mechanism 125 could be any suitable mechanism that can be used to attach a row unit 118 to the busbar 114 and/or toolbar 112 including but not limited to a clamp, bracket, brace, clasp, buckle, fastener, nut-and-bolt and/or nut-and-screw configuration, interlocking components, and/or any combination thereof. According to some embodiments, the securing mechanism 125 could be permanently installed on a row unit 118, the busbar 114, and/or the toolbar 112. According to some embodiments, the securing mechanism 125 can be removable such that it is not permanently installed on a row unit 118, busbar 114, and/or toolbar 112.

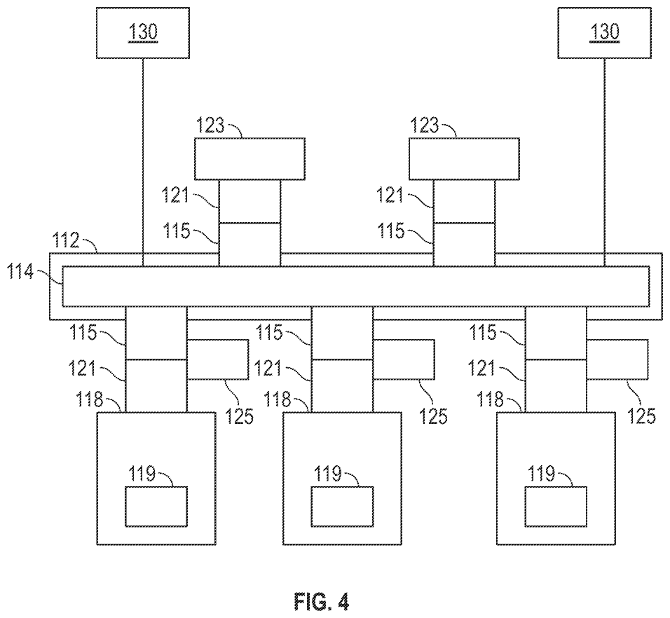

FIG. 4 shows a block diagram of the busbar 114 and other aspects of the planting implement 110 shown in FIG. 2. As shown in FIG. 4, each row unit 118 of the one or more row units can be operationally connected to the busbar 114 and/or toolbar 112 such that the row unit 118, and the one or more electrically driven elements 119 located thereon, is operationally connected to the busbar 114 and/or toolbar 112. As mentioned, to facilitate the connection between a row unit 118 and the busbar 114 and/or toolbar 112, each row unit can include a conductive portion 121 and, according to some embodiments, the busbar 114 and/or toolbar 112 can include one or more conductors 115. The conductors 115 can be made of any kind of conductive material(s) including but not limited to copper, brass, aluminum, and the like. The conductor 115 can take any suitable shape and/or form. For example, the conductor 115 could be a wire, a cable, a rivet, any kind of connector such as a clamp, or could simply be a portion of the busbar 114 and/or toolbar 112 wherein both the busbar 114 and/or toolbar 112 can act as a conductor according to some embodiments. Any conductive aspect of the busbar 114 and/or toolbar 112 can act as the conductor 115. As shown in FIG. 4, a securing mechanism 125 can be used to hold each row unit 118 in place such that row unit is in contact with or otherwise operationally connected to the busbar 114 and/or toolbar 112. The securing mechanism 125 can be used to join the conductive portion 121 of the row unit 118 and the conductor 115 of the busbar 114 and/or toolbar 112. According to some embodiments, the securing mechanism 125 can be used to join the row unit 118 directly to the busbar 114 and/or toolbar 112 without the use of a conductor 115 or a conductive portion 121. In such embodiments, the busbar 114 and/or toolbar 112, or portion thereof, acts as a conductor and the row unit 118 itself acts as a conductor in order to supply power to the row unit 118 and electrically driven element 119 located thereon. In other embodiments, the securing mechanism 125 can be used to join the conductive portion 115 of the busbar 114 and/or toolbar 112 to the row unit 118 without the use of a conductive portion 121. In some embodiments, the securing mechanism 125 can be used to join the busbar 114 and/or toolbar 112 to the conductive portion 121 of the row unit 118 without the use of a conductor 115. In each embodiment, the row units 118, and electrically driven elements 119 thereon, receive power from the busbar 114 and/or toolbar 112. The use of the busbar 114 allows for modularity and nearly infinite spacing for the row units 118, and electrically driven elements 119, thereon because the row units 118, and electrically driven elements 119 thereon, can be operationally connected to any portion of the busbar 114 and/or toolbar. For example, having the toolbar 112 comprise a busbar 114 would allow the row units 118 to be attached at location along the length thereof to receive the needed power. Still further, it is envisioned that the use of the busbar 114 for the toolbar 112 could aid in setting the accurate spacing between row units 118. The toolbar 112 could have settings for different spacing, which, when selected, may only activate the busbar 114 at the spacings. Therefore, the user would be able to determine when they have attached a component, such as a row unit 118, as the correct place by an indication from the toolbar 112 that the electrical connection at the hotspot location is achieved. Additional advantages can be understood.

According to some embodiments, the modular set up of the busbar 114 includes the ability to split the electrical supply into separate circuits at one location which allows new circuits to branch off the busbar 114 at any location. Thus, any component of the implement 110 can be connected to the busbar 114 and/or toolbar to form a complete circuit. Further, the busbar 114 is modular in that different portions of the busbar can supply electric power to different electronic components 123 at different voltage levels. Thus, if different electronic components 123 require different voltage levels for operation, the electronic components 123 can attach to different portions of the same busbar 114 and be supplied electric power at different voltage levels.

FIG. 4 also shows two generators 130 operationally connected to the busbar 114 and/or toolbar 112 to supply generated electric power to the busbar 114 and/or toolbar 112 wherein the busbar 114 and/or toolbar 112 distribute electric power to the electronic components 123 of the implement 110. While two generators 130 are shown in FIG. 4, any number of generators 130 can be included. According to some embodiments, the generators 130 are operationally connected to the busbar 114, toolbar 112, and/or electrical distribution box to supply generated electric power to the busbar 114, toolbar 112, and/or electrical distribution box wherein the busbar 114, toolbar 112, and/or electrical distribution box distribute electric power to the electronic components 123 of the implement 110. According to some embodiments, other methods, systems, and/or apparatuses can be utilized independently of and/or in conjunction with the zero or more generators 130 to generate electrical power. In some embodiments, electrical power can be generated via solar/photovoltaic technology. For example, zero or more solar panels can be mounted to the implement 110, wherein the solar panel(s) can generate electrical power. According to some embodiments, other methods, systems, and/or apparatuses used for electrical power generation can be used independently of and/or in conjunction with the generator(s) 130 and/or solar panel(s). These methods, systems, and/or apparatuses include, but are not limited to, chemical electrical power generation (such as with the use of a battery or batteries), microbial fuel cell(s), and/or any other power generation apparatus(es), method(s), and/or system(s) capable of being mounted on the implement 110. Throughout the disclosure, use of the term “generator(s) 130”, “the zero or more generators 130”, and/or any reference to generator(s) of any type can also refer to any other electrical power generation method, system, and/or apparatus including, but not limited to, solar panel(s), chemical power generation (such as a battery or batteries), and/or microbial fuel cell(s). Any power generation method, system, and/or apparatus used in any embodiment of the present disclosure can interact with the implement 110, and any components thereof, in generally the same manner as the generator(s) 130. For example, in an embodiment that uses solar panels, the solar panels can be located in/on the spaces 128 for generator(s) and/or in another suitable location, and the solar panels can be operationally connected to the busbar 114, toolbar 112, and/or electrical distribution box to supply generated electric power to the busbar 114, toolbar 112, and/or electrical distribution box wherein the busbar 114, toolbar 112, and/or electrical distribution box distribute electric power to the electronic components 123 of the implement 110.

As further shown in FIG. 4, according to some embodiments, other electronic components 123 on the implement 110, other than the electrically driven elements 119 on each row unit 118, can also be connected to the busbar 114 and/or toolbar 112 wherein each electronic component 123 includes a conductive portion 121 and the busbar 114 and/or toolbar 112 includes a conductor 115. According to at least some embodiments, electronic components 123 can be connected to the busbar 114 and/or toolbar 112 directly without the use of a conductive portion 121 of the electronic component 123 or a conductor 115 of the busbar 114 and/or toolbar 112. In such embodiments, the busbar 114 and/or toolbar 112, or a portion of either, and the electronic component 123 itself act as conductors to supply electric power to the electronic component 123. According to at least some embodiments, electronic components 123 can be connected to the busbar 114 and/or toolbar 112 wherein the electronic component includes a conductive portion 121 without the use of a conductor 115 of the busbar 114 and/or toolbar 112. According to at least some embodiments, electronic components 123 can be connected to the busbar 114 and/or toolbar 112 wherein the busbar 114 and/or toolbar 112 includes a conductor 115 without the use of a conductive portion 121 of the electronic component 123.

According to at least some embodiments, communication and control of the implement 110 can be performed via the electrical power supplied to the implement 110 and/or each row unit thereof. In other words, the implement 110 can use the power to communicate with and/or control aspects of the implement 110 such as the row units and/or electrically driven elements thereon. This kind of communication and/or control can include a modulated carrier signal to facilitate communication and/or control.

The agricultural implement 110 of FIG. 2 allows for the row units 118 thereof to be modular such that they operate on a plug-and-play basis. As noted herein, this can aid in positioning the row units 118 relative to the toolbar 112 at locations based upon spacing, such as to provide accurate spacing between units. Thus, one row unit 118 of the implement 110 can be independent of, operate separately, and/or perform a different agricultural function than another row unit 118 of the one or more row units included on the implement 110. Further, electrically driven elements 119 on each row unit 118 can be independent of, operate separately, and/or perform a different function than other electrically driven elements. Even further, different electronic components 123 of the implement 110 can be independent of, operate separately, and/or perform a different function than other electronic components 123. Additionally, the modular nature of the row units 118 of the implement 110 of FIG. 2 and the all electrical nature of the implement 110 allows for the row units 118 to be swapped out quickly and easily. Row units 118 can be connected and/or disconnected from the implement 110 easily and quickly to minimize the downtime spent by a farmer/user swapping out row units. Because some embodiments of the implement 110 are all electrical and do not include any hydraulic plumbing, the row units 118 can be swapped out without the need for disconnecting/reconnecting any aspects of hydraulic plumbing including but not limited to hoses, valves, fittings, hydraulic radiators, and the like.

As shown in FIG. 2, the implement 110 can include zero or more seed tanks 116. These seed tanks 116 are similar and/or the same as the seed hoppers mentioned above. The example embodiment of FIG. 2 includes four seed tanks 116 in a quad poly formation mounted on top of the toolbar 112. While four seed tanks 116 are shown in the example embodiment of FIG. 2, any number of seed tanks ranging from zero to N where N is any number greater than zero could be included in any suitable formation on the implement 110, whether on the toolbar 112 or elsewhere. For example, in some embodiments, seed tanks could be mounted on each row unit 118. While the seeds tanks 116 of the example embodiment of FIG. 2 are each 8 ft.×2 ft.×2.5 ft. and hold 128 bushels worth of seed, the seed tanks 116 could be any suitable size, dimensions, and/or volume. The seed tanks 116 allow the all electrical implement 110 to maintain the same bulk volume as an analogous implement that is hydraulicly, pneumatically, and/or mechanically driven. It is important to note that the elements of FIG. 2, or any other Figure, are not necessarily drawn to size. Positioning the seed tanks 116 on top of the toolbar 112 can add weight to the toolbar 112.

As shown in FIG. 2, the implement 110 can include zero or more row units 118. While the example embodiment of FIG. 2 shows 16 row units 118 included on the implement 110, any number of row units ranging from zero to N where N is any number greater than zero could be included. As mentioned above, the row units 118 can be modular in nature such that they operate on a plug-and-play basis. Also, as mentioned above, the row units 118 can be quickly and easily connected and/or disconnected from the implement 110.

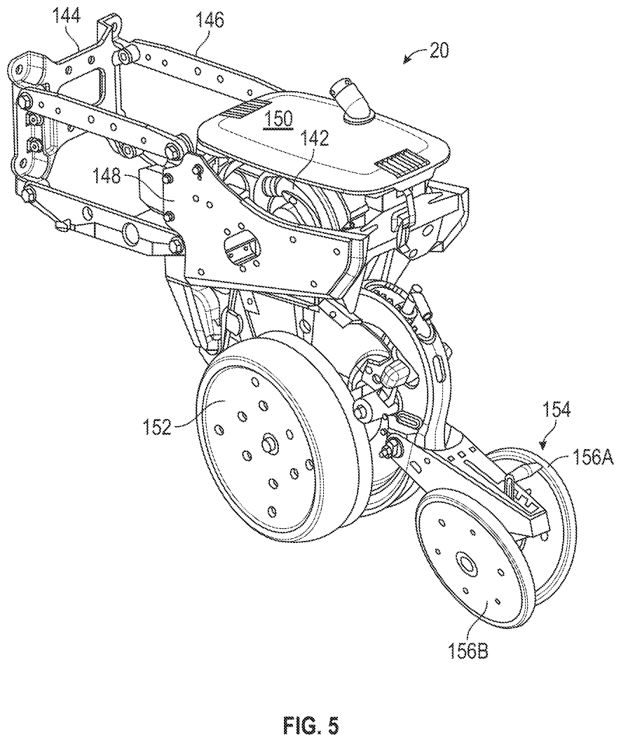

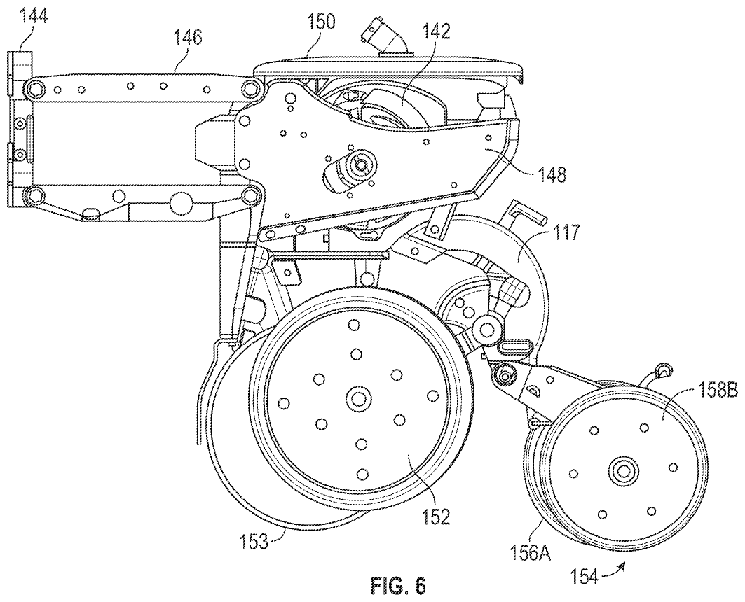

FIGS. 5 and 6 disclose an example embodiment of a row unit 118 of the plurality of row units 118, included as part of the implement 110, extending from the wing elements and/or the toolbar 112. A planter row unit 118 with an electrically powered air seed meter 142 positioned therewith is shown in FIGS. 5 and 6. According to some embodiments, The seed meters may be electrically driven in that a motor, such as a stepper motor, can be used to rotate the seed meters to aid in adhering seed thereto and to provide for dispensing of the seed in a controlled manner for ideal spacing, population, and/or placement. According to some embodiments, fan(s) are used to provide a pressure in the seed meter 142 to aid in adhering seed to a seed disk moving therein. Such fan(s) can be electrically powered. According to some embodiments, the seed meter 142 may utilize a negative or positive air pressure to retain and transport seed about one or more seed discs within the seed meter housing. The row unit 118 and seed meter 142 may be of the kind shown and described in U.S. Pat. No. 9,282,691, which is hereby incorporated in its entirety. According to some embodiments, the seed meter, and other components of U.S. Pat. No. 9,282,691, may be electrically powered. It should be appreciated that aspects of embodiments of the present disclosure contemplate other types of seed meters, including mechanical, brush, finger, or the like, which may be used with aspects and/or embodiments of the present disclosure and/or may be electrically powered. In addition, the seed meter may be a multi-hybrid seed meter that is capable of dispensing one of a plurality of types, varieties, hybrids, etc. of seed at a row unit, such as by the use of multiple seed discs within the seed meter housing. Such multi-hybrid seed meters can be electrically powered according to some embodiments. Thus, according to some embodiments, the all electrical implement 110 can be multi-hybrid such that the implement 110 is capable of planting one of a plurality of types, varieties, hybrids, etc., and a user can choose between the plurality of types, varieties, hybrids, etc. of seed to select which type, variety, hybrid, etc. to plant. In addition, when the implement 110 is not a planting implement, the row units may take other forms, such as those for engaging with the ground associated with the particular type of implement (e.g., tillage equipment or the like).

Each row unit 118 includes a U-bolt mount (not shown) for mounting the row unit 118 to the planter frame or toolbar 112 (on central frame and/or wing elements), as it is sometimes called, which may be a steel tube of 5 by 7 inches (although other sizes and materials are used including aluminum, copper, and the like). However, other mounting structures could be used in place of the U-bolt. The mount includes a face plate 144, which is used to mount left and right parallel linkages 146. Each linkage may be a four bar linkage, as is shown in FIGS. 5 and 6. The double linkage is sometimes described as having upper parallel links and lower parallel links, and the rear ends of the parallel links are pivotally mounted to the frame 148 of the row unit 118. Any aspect of the row unit 118 such as the face plate 144 of the row unit 118, linkage(s) 146 of the row unit 118, a portion of the frame 148 of the row unit 118, a mount (such as a U-bolt mount) of the row unit 118, and/or any other suitable component including but not limited to any other portion of the row unit 118 can comprise the securing mechanism 125 used to mount a row unit 118 to the busbar 114 and/or toolbar 112. Additionally, any conductive aspect of the row unit 118 could comprise the conductive portion 121 used to operationally connect to at least a portion of the busbar 114 and/or toolbar 112 in order to receive power from the busbar 114 and/or toolbar 112. The frame 148 includes a support for the electrically powered air seed meter 142 and seed hopper 150, as well as a structure including a shank 117 for mounting a pair of ground-engaging gauge wheels 152. The frame 148 is also mounted to a closing unit 154, which includes a pair of inclined closing wheels 156A, 156B. The row unit 118 also includes a pair of opener discs 153. While the row unit 118 shown in FIGS. 5 and 6 is configured to be used with a bulk fill seed system, it is to be appreciated that the row unit 118 may have one or more seed hoppers 150 at each of the row units 118. Exemplary versions of row units with individual hoppers are shown and described in U.S. Pat. No. 9,420,739, which is hereby incorporated in its entirety. In addition, a high speed planting implement, such as that disclosed in U.S. Pat. No. 10,842,072, which is hereby incorporated in its entirety, could be utilized with any of the aspects of any embodiments disclosed herein. Each component of the row unit 118 shown in FIGS. 5 and 6 can be electrically powered.

The implement 110 and row units 118 shown and described in FIGS. 5 and 6 include an electrically powered air seed meter 142 for singulating and transporting seed or other particulate material from the seed delivery source to the created furrow in the field prior to the closing wheels 156A, 156B closing said furrow.

The row units 118 of the implement 110 shown in FIG. 2 can operate electrically. For example, in some embodiments, each of the row units 118 can include at least one integrated vacuum that operates electrically. Each of the row units 118 can include an electronic seed metering system wherein seed metering and delivery of seed to the ground is electrically operated. To perform seed metering, the seed metering system of each of the row units 118 can include an electrically operated meter or any other suitable seed meter. In some embodiments, each of the row units 118 can include an electrically operated/electric pump for use with fertilizer. Each row unit 118 can apply liquid, solid, and/or particulate fertilizer to an agricultural field wherein the fertilizer is supplied via the fertilizer tanks 122 and is applied via the fertilizer pump in each row unit 118.

According to some embodiments, downforce applied by each row unit 118 of the implement 110 can be controlled and/or varied electronically. The control and/or variation of downforce can be achieved by any suitable component(s) such as by the use of an electronic actuator located on each row unit or on any other suitable location on the implement 110, such as on the toolbar 112 and/or busbar 114. According to at least some embodiments, downforce of the toolbar 112 and/or busbar 114 can be electronically controlled and/or varied. This control and/or variation of the downforce of the toolbar 112 and/or busbar 114 can be achieved by any suitable component(s) such as by the use of an electronic actuator located on the toolbar 112 and/or busbar 114 or any other suitable location. According to at least some embodiments, the ability to control and/or vary downforce of the row unit(s) 118, the toolbar 112, and/or the busbar 114 can include technology such as that disclosed in U.S. U.S. Pat. Nos. 11,140,812; 11,224,153; 10,477,753; 10,512,209; and/or U.S. patent application Ser. No. 17/813,982 filed Jul. 21, 2022, which are all hereby incorporated by reference in their entirety. Additionally, according to at least some embodiments the ability to control and/or vary downforce of the row unit(s) 118, the toolbar 112, and/or the busbar 114 can be achieved electronically by electrically powering any of the downforce technology disclosed in U.S. Pat. Nos. 11,140,812; 11,224,153; 10,477,753; 10,512,209; and/or U.S. patent applicant Ser. No. 17/813,982.

According to at least some embodiments, operation of the row units 118 can include electric and hydraulic integration. In such embodiments, the row units 118 can be powered electrically and can include electrically powered components wherein such components have subcomponents that include hydraulics. As stated above, an example is an electro-hydraulic actuator that uses electricity to operate a pump on the actuator to move the hydraulic fluid. Thus, while hydraulic fluid is used to move an actuator rod, the movement and actuator are powered by electricity.

As mentioned, the agricultural planting implement 110 of FIG. 2 is an all electrical planter. In some embodiments, the implement 110 operates without the use of any sort of hydraulic plumbing wherein such plumbing includes but is not limited to hoses, valves, fittings, hydraulic radiators, and the like. Thus, according to some embodiments, no hydraulic hose(s) running from the agricultural vehicle 100 to the agricultural implement 110 are needed/included. The electronic components 123 of the implement 110 such as row units 118, and electrically driven elements 119 thereon, operate electrically to perform agricultural functions such as planting, fertilizing, spraying, tilling, discing, and the like. Additionally, the implement 110 operates completely and totally electrically in that other functionality of the implement 110 such as any folding, lifting, tilting, rotating, pivoting, and other movements of the implement 110, or components thereon such as the elements of the toolbar 112, are performed electrically. According to some embodiments, the implement 110 can include actuators, such as electric ram actuators, to perform some functions such as folding, lifting, tilting, rotating, pivoting, and other movements of the implement 110.

According to some embodiments, the all electrical agricultural planting implement 110 operates without the use of pneumatic system(s). Such pneumatic systems can include hoses, valves, fittings, and the like. Such pneumatic systems, and components thereof, are prone to degrade, deteriorate, and/or leak. Thus, according to some embodiments, the implement 110 does not include any pneumatic system(s), or components thereof, to power any aspects and/or components of the implement 110.

As shown in FIG. 2, the implement 110 can include zero or more tracks 120. While the example embodiment of FIG. 2 includes six tracks 120, in other embodiments any number of tracks ranging from zero to N where N is any number greater than zero could be included. It is contemplated that the term wheels and tracks can be used interchangeably for purposes of the agricultural planting implement 110. Thus, the implement 110 is not to be limited to the use of either wheels and/or tracks, and it is contemplated herein that either and/or both can be used on a same or different unit. In addition, it is contemplated that the wheels or tracks 120 can be interchangeable such that weather conditions, field conditions, and other conditions can be determinative as to whether wheels, tracks, or some combination are utilized together. The tracks 120 help the implement 110 to move when the implement 110 is arranged for transportation and/or when it is arranged to perform an agricultural function. In some embodiments, each of the tracks 120 can include an industrial motor. Each of the tracks 120 and/or motor thereof can be electrically powered according to some embodiments.

As shown in FIG. 2, the implement 110 can include zero or more fertilizer tanks 122. The example embodiment of FIG. 2 includes four fertilizer tanks 122 in quad poly formation mounted on the front of the toolbar 112 (the side of the toolbar 112 from which the tongue 126 extends) wherein each of the fertilizer tanks 122 is a liquid fertilizer tank and has dimensions 6 ft.×2 ft.×2 ft. and can hold 718 gallons of liquid fertilizer. The inclusion of the fertilizer tanks 122 and/or seed tanks 116 on the toolbar 112 provide for proper and/or even weight distribution both when the implement 110 is arranged such that it is ready for performing an agricultural function such as planting and also when the implement 110 is arranged such that it is ready for transport. Proper and/or even weight distribution ensures that the implement 110 is stable, does not inadvertently tip or lean, and provides the proper amount of down force when performing an agricultural function such as planting, fertilizing, spraying, tilling, discing, and the like. In other embodiments, any number of fertilizer tanks 122 ranging from zero to N where N is any number greater than zero can be included. In other embodiments, the fertilizer tanks 122 can be liquid fertilizer tanks, solid fertilizer tanks, and/or a combination thereof. Additionally, in other embodiments, any suitable size, dimensions, volume, and/or capacity of fertilizer tanks 122 can be included in any suitable formation. Also, in other embodiments, the fertilizer tanks 122 can be positioned in any suitable location on the planting implement 110 and do not have to be positioned on the front of the toolbar 112. For example, in some embodiments, the liquid fertilizer tanks 122 can be positioned on each individual row unit 118 and/or on top of the toolbar 112. According to some embodiments, the fertilizer tanks 122 can be permanently and/or temporarily mounted on the busbar 114, toolbar 112, and/or any other suitable portion of the planting implement 110. The fertilizer tanks 122 could be secured to the busbar 114, toolbar 112, and/or any other portion of the implement 110 via the use of a clamp, bracket, brace, clasp, buckle, fastener, nut-and-bolt and/or nut-and-screw configuration, interlocking components, welding, and/or any combination thereof.

As shown in FIG. 2, the implement 110 can include transport wheels 124. The example embodiment of FIG. 2 includes two transport wheels 124 wherein the transport wheels 124 are dual retractable transport wheels located on the tongue 126 near the toolbar 112. In other embodiments, any number of transport wheels 126 ranging from zero to N where N is any number greater than zero can be included. Additionally, in other embodiments, the transport wheels 126 can be located in any suitable location on the implement 110. The transport wheels 124 help the implement 110 to move when the implement 110 is arranged for transportation and/or when it is arranged to perform an agricultural function. In some embodiments, each of the transport wheels 124 can include an industrial motor. Each of the transport wheels 124 and/or the motor thereof can be electrically powered according to some embodiments.

As shown in FIG. 2, the implement 110 can include a tongue 126. The tongue 126 can be retractable such that the tongue 126 can retract when transporting the implement 110 and can extend when using the implement 110 to perform an agricultural function such as planting, fertilizing, spraying, tilling, discing, and the like. As mentioned, the tongue 126 can extend from the middle of the busbar 114 and/or toolbar 112 in a generally transverse direction such that the tongue 126 and busbar 114 and/or toolbar 112 are perpendicular.

As shown in FIG. 2, the implement 110 can include zero or more generators 130 and zero or more spaces 128 for generators. The example embodiment of FIG. 2 includes two spaces 128 for generators and two generators 130. In some embodiments, the number of spaces 128 for generators and/or the number of generators 130 may range from zero to N where N is any number greater than zero. Each generator 130 can be any suitable electric power generator, such as any off-the-shelf generator. Each generator 130 can be a drive regulated generator. The implement 110 and/or each of the zero of more generators 130 can plug into, be affixed to, and/or otherwise access the power take-off (PTO) of an agricultural vehicle (e.g., a tractor) that is attached to the implement 110 wherein the zero or more generators 130 use the vehicle's PTO as a power source such that the zero or more generators 130 are driven by the vehicle's PTO. In some embodiments, the zero or more generators 130 can utilize battery power such that battery power acts as the power source for the zero or more generators 130. According to some embodiments, this battery power can comprise one or more batteries. Such batteries can be organized in a battery bank and/or cluster. In some embodiments, the battery bank and/or cluster can be permanent wherein it can be recharged. In some embodiments, the battery bank and/or cluster can be interchangeable and/or replaceable wherein a depleted battery bank and/or cluster can be removed and a new, fully charged battery bank and/or cluster can be installed. According to some embodiments, the battery bank and/or cluster can comprise a battery power pack. According to some embodiments, battery power, such as the one or more batteries, the battery bank and/or cluster, and/or the battery power pack can be used to directly provide electrical power to the busbar 114, toolbar 112, electrical distribution box, and/or electronic components 123 on the implement 110 without the use of generator(s) 130. In such embodiments, the one or more batteries, the battery bank and/or cluster, and/or the battery power pack can operate in generally the same manner and perform the same functionality as the generator(s) 130.

In some embodiments, the agricultural vehicle 100 of FIG. 1 can attach to the agricultural planting implement 110 of FIG. 2 such that the vehicle 100 is used to tow the implement 110 and the generators 130 of the implement 110 plug into, affix to, and/or otherwise access the PTO of the vehicle 100. The generators 130 generate electric power. According to some embodiments, the generators 130 are operationally connected to the busbar 114, toolbar 112, and/or electrical distribution box to supply the generated electric power to the busbar 114, toolbar 112, and/or electrical distribution box wherein the busbar 114, toolbar 112, and/or electrical distribution box distribute electric power to the electronic components 123 of the implement 110. While the generators 130 and spaces 128 for generators of the example embodiment of FIG. 2 are shown to be located on the tongue 126 of the planting implement 110, in other embodiments, the generators 130 and spaces 128 for generators of the disclosed system can be located in any suitable location including but not limited to other locations on the implement 110, on the agricultural vehicle 100, and/or any other suitable location. In some embodiments, each row unit 118 could include its own generator 130 and/or space 128 for generator. The generators 130 can be operationally connected to the busbar 114, toolbar 112, and/or electrical distribution box to supply electric power to the busbar 114, toolbar 112, and/or electrical distribution box wherein the busbar 114, toolbar 112, and/or electrical distribution box distribute the power to the electronic components of the implement 110.

According to some embodiments, the spaces 128 for generators can be any kind of structure capable of supporting a generator including but not limited to a platform, a pan-like structure that includes a shallow container having sides flaring upward, an enclosure such as a box-like structure, and the like.

In at least some embodiments, the implement 110 can include electrically powered hydraulic units where needed to provide hydraulic power if necessary. Such hydraulic units can be relatively small. Such hydraulic units can be self-contained and can include a motor, a fluid reservoir, a pump, an accumulator, a filter, a cooler, a heater, and/or a controller. Such hydraulic units can be used for folding, lifting, tilting, rotating, pivoting, and/or other movements of the implement 110. According to some embodiments, such hydraulic units can be used for any other suitable purposes on the implement 110.

Additionally, in some embodiments, the implement 110 can include zero or more batteries. The batteries could be permanently installed wherein they could be recharged. Alternatively, the batteries could be quick-change/hot-swap batteries that can be easily swapped out by a user rather than permanently installed batteries. In some embodiments, the batteries can be located centrally on the implement 110. In alternative embodiments, the batteries can be positioned at each row unit 118 on a row-by-row basis. The use of batteries, whether they are located centrally or at the row units 118, can add weight to the implement 110 such that the implement 110 is stable and proper down force is maintained when performing an agricultural function.

In some embodiments, the implement 110 can include zero or more hydrogen fuel cells. The hydrogen fuel cells can convert chemical energy of hydrogen into electricity to power the functionality of the implement 110 including functionality of electronic components 123 thereon such as the functionality of the row units 118, and electrically driven elements 119 thereon, as well as folding, lifting, tilting, rotating, pivoting, and/or other movements of the implement 110. The zero or more hydrogen fuel cells can include an anode, a cathode, and/or an electrolyte. Some embodiments of the implement 110 that include the use of hydrogen fuel cell(s) can also include hydraulic plumbing while some embodiments of the implement 110 that include the use of hydrogen fuel cell(s) do not also include the use of hydraulic plumbing.

According to some embodiments, any and/or all of the electrically powered hydraulic unit(s), batter(ies), and/or hydrogen fuel cell(s) can be used in combination with the all electrical aspects of the implement 110.

As shown in FIG. 2, the implement 110 can include a hitch 132 located at an end of the tongue 126 opposite that of the end of the tongue 126 upon which the toolbar 112 is located. The hitch 132 is configured to attach the implement 110 to an agricultural vehicle such that the agricultural vehicle can tow the implement 110. In some embodiments, the agricultural vehicle 100 of FIG. 1 can be attached to the agricultural implement 110 of FIG. 2 via the hitch 109 of the vehicle 100 and/or the hitch 132 of the implement 110 wherein the agricultural vehicle 100 can tow the agricultural implement 110. The hitch 132 can be any off-the-shelf hitch capable of attaching an agricultural vehicle to an agricultural implement. Additionally, in some embodiments the implement 110 and/or vehicle 100 is autonomous and/or self-propelled such that it is capable of traversing an agricultural field and performing agricultural function(s) independently without the need to be towed by a vehicle such as disclosed in U.S. Pat. No. 10,104,824, which is hereby incorporated in its entirety.

In some embodiments, the planting implement 110 of FIG. 2 can include zero or more flex joints. Flex joints allow for easy flexibility and/or maneuverability between any and/or all components of the implement 110. Flex joints also allow for easy turning and preservation of proper down force when the implement 110 is performing an agricultural function. Flex joints also provide easy movement of components of the implement 110 when the implement 110 is being converted from a transport arrangement to an arrangement wherein the implement 110 is ready to perform an agricultural function and vice versa. The folding capabilities of the implement 110 combined with the retractable nature of the tongue 126, the flex joints, the tracks 120, and the transport wheels 124, allow for narrow and easy transport of the implement 110.

In some embodiments, the planting implement 110 of FIG. 2 can include an electrical distribution box located on the implement 110. The electrical distribution box can be used for power division, distribution, measurement, protection, and control. The electrical distribution box can be ultra-violet (UV) resistant and/or can be fire retardant. According to some embodiments, the electrical distribution box can be made of engineering thermoplastic(s). Examples of engineering thermoplastics include polyamides, polyesters, polycarbonates, polyacetals, and acrylonitrile butadiene styrene. According to other embodiments, the electrical distribution box could be made of an electrically conductive metal including but not limited to copper, aluminum, and the like. Such metallic distribution boxes can include an epoxy coating such that the box is insulated. According to other embodiments, the electrical distribution box can be made of thermoset plastic(s) such as sheet molding compound(s) (SMC). Such thermoset plastic boxes can be electrically non-conductive. According to all embodiments, the electrical distribution box is weather resistant such that it is effective for outdoor use. According to some embodiments, the electrical distribution box can be recyclable.

The electrical distribution box can be used to distribute electric power to aspects of the implement 110 such as the electronic components 123 thereon. The electrical distribution box can be used in conjunction with the busbar 114 and/or toolbar 112 to distribute electric power in some embodiments and can be used without the busbar 114 and/or toolbar 112 to distribute electric power according to other embodiments. Some embodiments include a busbar 114 without an electrical distribution box while other embodiments include an electrical distribution box without a busbar 114. Other embodiments include the use of both a busbar 114 and an electrical distribution box. In such embodiments, the busbar 114 and/or toolbar 112 and the electrical distribution box can operate in series and/or in parallel to receive power from the generator(s) 130 and distribute such power to the electronic components 123 of the implement 110. In some embodiments, one or more power cables, wires, or any other suitable mechanism can be used to operationally connect the zero or more generators 130 to the electrical distribution box, busbar 114, and/or toolbar 112 to send generated power from the generators 130 to the electrical distribution box, busbar 114, and/or toolbar 112 wherein the electrical distribution box, busbar 114, and/or toolbar 112 can then distribute electric power to electronic components 123 of the implement 110. Additional power cables can be used, according to some embodiments, on each row unit 118 to provide power to the electrically driven elements 119 thereon. While one or more power cables can be used in some embodiments, any suitable method of connection can be used to send the generated power to the planting implement.

The implement 110 of FIG. 2 can include a voltage converter. The voltage converter can be used to step up and/or step down the voltage provided by the generator(s) 130, electric distribution box, busbar 114, toolbar 112, and/or the power source for the generator(s) 130, which can be the PTO of the attached agricultural vehicle according to some embodiments. According to differing embodiments, the voltage converter can perform voltage conversion can occur between the PTO of the attached agricultural vehicle and the generator(s) 130, between the generator(s) 130 and the electronic distribution box, busbar 114, and/or toolbar 112, and/or between the electronic distribution box, busbar 114, and/or toolbar 112 and the electronic components 123 of the implement 110. The voltage converter takes in, accepts, and/or receives an input voltage from the generator(s) 130, electric distribution box, busbar 114, toolbar 112, and/or PTO of the attached agricultural vehicle. In some embodiments, the voltage converter can be included as part of the generator(s) 130. Also, in some embodiments, the generator(s) 130 can provide voltage conversion such as step-up and/or step-down conversion. In a step-up voltage conversion, the output voltage of electric power leaving the voltage converter is greater than the input voltage received by the voltage converter. In a step-down voltage conversion, the output voltage of electric power leaving the voltage converter is less than the input voltage received by the voltage converter. In some embodiments, the voltage converter can be rated to 1000 watts. However, other wattages are contemplated herein. The voltage converter can be used to step down the voltage level to 48 V, 24 V, 12 V, and/or any other suitable voltage level so that the generated power can be used to power aspects of the planting implement 110. For example, one or more electronic components 123 of the implement 110, such as electrically driven elements 119 located on one of the one or more row units 118 may need 12 V, 24 V, 48 V, and/or any other voltage level of power in order to operate properly. Thus, the voltage can be converted to 12 V, 24 V, 48 V, or any other suitable voltage level before being supplied to the electronic components 123 such as one or more row units 118, electrically driven elements 119 thereon, and/or any other aspect of the implement 110. According to some embodiments, the voltage converter can perform DC to DC voltage conversion, AC to DC voltage conversion, DC to AC voltage conversion, and/or AC to AC voltage conversion. In some embodiments, the voltage conversion technology disclosed in U.S. Provisional Patent Application No. 63/260,847, filed Sep. 2, 2021, which is hereby incorporated in its entirety, can be included as part of the implement 110 and/or as part of the vehicle 100. According to some embodiments, the voltage converter can make use of a relay switch and/or an integrated circuit to selectively enable and/or disable the voltage converter depending on the voltage level required by the electronic components 123 that will receive electric power.

As mentioned below, in some embodiments, the implement 110 can use Bluetooth and/or other wireless communication and/or control system(s) to perform communication and/or control between a control unit and the electronic components 123 such as row units 118, and the electrically driven elements 119 thereon. Additionally, in some embodiments, the implement 110 can use a communication and/or control system such as that disclosed in U.S. Provisional Patent Application Nos. 63/200,061 filed on Feb. 12, 2021, and 63/267,865 filed on Feb. 11, 2022, which are both hereby incorporated by reference in their entirety. The communication and/or control system(s) included help to facilitate the plug-and-play nature of the row units 118 of the implement 110. According to some embodiments, a display unit and associated electronic communication and/or controls can be used, such as that disclosed in U.S. Provisional Patent Application Nos. 63/200,061 and 63/267,865, which are hereby incorporated by reference in their entirety. According to some embodiments, the display can be a ruggedized touch screen tablet. A user can operate an agricultural implement, such as the implement 110 disclosed herein, via the display.

In some embodiments, while the implement 110 operates electrically in that no hydraulic hoses connect the implement 110 to its tow vehicle (e.g., agricultural vehicle 100) to supply hydraulic power from the tow vehicle to the implement 110, hydraulic power can be generated on the implement 110. Hydraulic power can be generated via electrically powered pumps. Any number of pumps ranging from zero to N where N is any number greater than zero can be included. These pumps can be relatively small and can be positioned on the implement 110 near the target for which the power is needed. For example, if power is needed for lifting and/or pivoting, the pumps can be placed near the lift and/or pivot cylinder, and/or actuators thereof, of the implement 110. Such pumps can be hydrostatic and/or hydrodynamic. Additionally, the one or more pumps could be gear pumps, rotary vane pumps, screw pumps, bent axis pumps, inline axial piston pumps, radial piston pumps, and/or any combination thereof.

In some embodiments, the implement 110 can include a path planning system. The path planning system can determine how much seed, fertilizer, and/or other substance each row unit 118 will require. The path planning system can then preload and/or preset the row units 118 to deliver the correct amount of seed, fertilizer, and/or other substance at the correct time. The path planning system can also include automatic steering. According to some embodiments, the path planning system can be and/or incorporate aspects of the predictive path lookahead system disclosed in U.S. Patent Application No. 63/268,156 filed Feb. 17, 2022, which is hereby incorporated by reference in its entirety.

In some embodiments, the path planning system can include cartridge-based inputs used to preset and/or configure row units based on a specified task, function, and/or segment of a function. Such a cartridge could take the form of a data file saved on a device, flash drive, CD-ROM, data cartridge, any kind of tape cartridge such as a cassette tape, ROM cartridge, RAM pack, and the like. The input can include an indication of what substance is loaded into each row unit, which could include different types of seed such as but not limited to corn, soybeans, and the like. Other substances to be loaded into each row unit could include liquid fertilizer, solid fertilizer, herbicide, pesticide, and the like. The input could also include instructions that control how each row unit operates. For example, the instructions could control when each row unit is dispensing the substance that has been loaded into it and when it is not dispensing the substance that is loaded into it. The input could also include identification of which agricultural field, and/or portion therein, an agricultural function is to be performed. The input could also include instructions on what path the implement and/or tow vehicle attached to the implement should follow. For example, a cartridge-based input could be used wherein the input is designed to plant corn in a specific agricultural field. The input would indicate that corn seeds are to be loaded into the row units and/or control the loading of the seeds, the input would control turning each row unit ON and/or OFF to control when each row unit is dispensing seeds and when it is not, and the input would control the path of the implement and/or tow vehicle towing the implement. This same cartridge-based approach can be used for other tasks, functions, and/or segments of functions. For example, the cartridge-based approach could be used wherein the input is designed to apply liquid fertilizer to a specific portion of a specific agricultural field. The input can include taking many factors into account to consider when to dispense a substance from each row unit and when not to dispense a substance. Such factors can include but are not limited to map information related to a specific agricultural field, the use of location sensors and/or the use of global positioning system (GPS), soil characteristics of the agricultural field (such as moisture content, compaction, temperature, and the like), weather and/or environmental conditions such as ambient temperature, humidity, wind, precipitation, and the like.

In some embodiments, the cartridge-based input can include the use of radio-frequency identification (RFID) wherein an RFID scanner is included to identify outputs based on the cartridge-based inputs (such as a specific task, function, and/or segment of a function) and to then communicate the outputs to the path planning system wherein, according to some embodiments, the path planning system can display the outputs to a user/operator and/or automatically perform the task, function, and/or segment of a function. For example, based on the inputs, a signal could be sent to provide instructions to the implement 110 and/or the vehicle towing the implement 110 to perform the specified task, function, and/or segment of a function. Said signal can be incorporated with the display unit and system of either and/or both of U.S. Provisional Patent Application Nos. 63/200,061 and/or 63/267,865 such that the signal triggers a display to show instructions to a user/operator wherein the display is controlled via the display unit.

In some embodiments, blockchain technology can be included to identify outputs based on the cartridge-based inputs. The blockchain is a list of records, called blocks or nodes, that are linked using cryptography. In certain embodiments, a block may include a grouping of data or data records. A block of a blockchain may include a link to an immediately preceding block in the blockchain, a subsequent block in the blockchain, a different block in the blockchain, or a different block in another blockchain. Each block contains a cryptographic hash of the previous block, a timestamp, and transaction data. In a preferred embodiment, the transaction data is represented as a Merkle tree (also called a hash tree), or a tree in which every leaf node is labelled with the hash of a data block, and every non-leaf node is labelled with the cryptographic hash of the labels of its child nodes. Merkle trees allow efficient and secure verification of the contents of large data structures and are a generalization of hash lists and hash chains.

In some embodiments, a docking station can be included such that the cartridges of the cartridge-based system can connect with and/or plug into the docking station and be reloaded with different data, content, instructions, and/or any kind of information such as path information. The docking station can be any suitable device capable of receiving a cartridge, as described above, and loading data, content, instructions, and/or any kind of information onto the cartridge. Thus, a user can load data, content, instructions, and/or any kind of information such as path and/or planting information onto a cartridge wherein said cartridge can be reused to operate an agricultural implement and/or agricultural vehicle wherein a different task, function, and/or segment of a function is performed based on different data, content, instructions, and/or any kind of information. The docking station can be static. According to some embodiments, the docking station could be mounted in the agricultural implement 110 and/or in a vehicle towing the implement 110. According to other embodiments, the docking station could be remote from the implement 110 and/or any tow vehicle thereof.

In some embodiments, the implement 110 can have power surge protection. The implement 110 can include one or more surge protective devices that protect aspects of the implement 110 in the event of a power surge, power spike, and/or any other increase in voltage above a desired level. In the event of a power surge, power spike, and/or any other increase in voltage above a desired level, the one or more surge protective devices can divert electricity away from aspects of the implement 110 such that those aspects are not damaged.

In some embodiments, the implement 110 can include a reservoir to store electric power wherein said stored electric power can be used to power aspects of the implement 110. This stored electric power can be continuously stored while the implement 110 is in motion. Such a reservoir could be any type of device suitable to store electric power such as one or more capacitors and/or a superconducting magnetic energy storage system (SMES). The SMES can include a superconducting coil, a power conditioning system, and a refrigerator. The SMES can store electric power in a magnetic field created by the flow of current in a superconducting coil that is cooled to a temperature below its superconducting critical temperature (temperature at which the coil acts as a superconductor). The superconducting coil can they become charged wherein the current does not decay and electric power (in the form of magnetic energy) can be stored indefinitely. The stored power/energy can be released by discharging the superconducting coil.

In some embodiments, very few (one or two) hydraulic hoses can connect the implement 110 and its tow vehicle (e.g., agricultural vehicle 100) wherein hydraulic power can be supplied to the implement 110 from the tow vehicle. Such hydraulic power can be solely dedicated to major cylinder systems such as lifting and/or pivoting. While one or two hydraulic hoses can be used, it is contemplated that the number of hydraulic hoses connecting the implement 110 and its tow vehicle can range from zero to N where N is any number greater than zero.

In some embodiments, the implement 110 can be used to supply electric power to separate agricultural equipment including but not limited to a seed tender, seed cart, and the like. This other agricultural equipment can then operate using the electric power supplied by the implement 110. According to embodiments in which the implement 110 provides electric power to separate agricultural equipment, wire(s) and/or cable(s) can be included that run from the electrical distribution box, busbar 114, toolbar 112, generators 130, batterie(s), storage reservoir, and/or any other aspect of the implement 110 to the separate agricultural equipment such as a seed tender, seed cart, and the like. According to at least some embodiments, the implement 110 can include one or more outlets and/or plugs wherein separate agricultural equipment could connect to the one or more outlets and/or plugs of the implement 110 via wire(s) and/or cable(s) in order to receive electric power from the implement 110.

In some embodiments, the implement 110 can include or more electromagnetic cylinders and/or one or more electro-hydraulic actuators with self-containing hydraulic fluid to generate and provide power to aspects of the implement 110. The electromagnetic cylinder(s) can take the form of an electromagnetic coil wherein a wire, or other suitable conductor, is wound into a coil. Electrical current may pass through the coil, wherein the electrical current is supplied from the generator(s) 130, electrical distribution box, busbar 114, and/or toolbar 112. The electro-hydraulic actuator can be self-contained and can be operated solely by electrical power. This electrical power can be supplied from the generator(s) 130, electrical distribution box, busbar 114, and/or toolbar 112. Electromagnetic cylinders and/or electro-hydraulic actuators eliminate the need for hydraulic tubing and/or any other aspects of hydraulic plumbing. According to some embodiments, one or more electro-hydraulic actuators can each include a pump and a hydraulic cylinder wherein each electro-hydraulic actuator can drive the pump which is connected to the hydraulic cylinder in order to generate electric power.

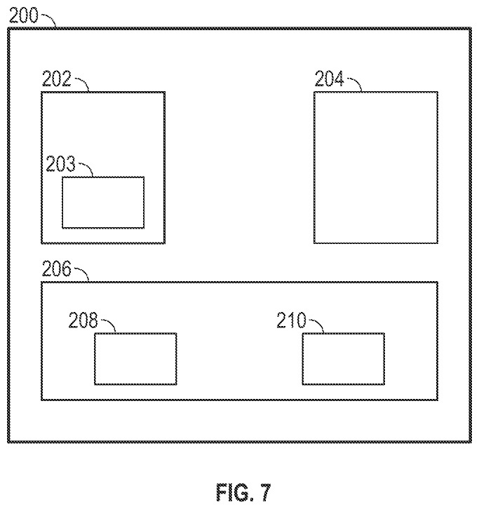

FIG. 7 shows a block diagram of an example embodiment of a communication/control system 200. As shown in FIG. 7, the communication/control system 200 can include an agricultural implement 202 comprising one or more electronic components 203, an agricultural vehicle 204, and a control unit 206 that comprises a two-way data transmitter/receiver component 208 and a user interface 210.

The agricultural implement 202 can be an agricultural planting implement and/or any other kind of agricultural implement such as a sprayer, plow, tiller, ripper, fertilizer, spreader, and the like. In some embodiments the agricultural implement 202 is the all electrical agricultural planting implement 110 shown in FIG. 2. All aspects of the communication/control system 200 are compatible with the planting implement 110 shown in FIG. 2. In other words, the communication/control system 200 can be used to communicate with and/or control the agricultural planting implement 110 and all or some aspects thereof such as electronic components 203 thereon.

As shown in FIG. 7, in some embodiments, the system 200 can include an agricultural vehicle 204. The agricultural vehicle 204 can be used to tow the agricultural implement 202. The agricultural vehicle 204 can be any type of tow vehicle, such as a tractor, that can be used to tow an agricultural implement. In some embodiments, the agricultural vehicle 204 can be the agricultural vehicle 100 shown in FIG. 1.

As shown in FIG. 7, in some embodiments, the system 200 can include a control unit 206 wherein the control unit 206 includes a transmitter/receiver component 208. In some embodiments, the control unit 206 can include a user interface 210, wherein the user interface 210 includes a display such that a user can interact with the control unit 206 wherein such interaction can include but is not limited to inputting commands and/or information to the control unit 206, receiving output from the control unit 206, and the like. In some embodiments, the control unit 206 can be a tablet, phone, or other device that includes a user interface. The control unit 206 can be handheld and/or mobile. According to some embodiments the control unit 206 and/or system 200 can include the use of an electronic system, which may include a display unit with processor and communications, such as described in U.S. Provisional Patent Application Nos. 63/200,061 and/or 63/267,865.

A user interface is how the user interacts with a machine. The user interface 210 can be a digital interface, a command-line interface, a graphical user interface (“GUI”), oral interface, virtual reality interface, or any other way a user can interact with a machine (user-machine interface). For example, the user interface (“UI”) 210 can include a combination of digital and analog input and/or output devices or any other type of UI input/output device required to achieve a desired level of control and monitoring for a device. Nonlimiting examples of input and/or output devices include computer mice, keyboards, touchscreens, knobs, dials, switches, buttons, speakers, microphones, printers, LIDAR, RADAR, etc. Input(s) received by the UI 210 can then be sent to a microcontroller and/or any type of controller to control operational aspects of a device.

The user interface 210 can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), a touchscreen display, etc. The user interface 210 also can be configured with a microcontroller to display conditions or data associated with a main device in real-time or substantially real-time.

In some embodiments, the control unit 206 can include an intelligent control. The intelligent control (i.e., a controller, microcontroller, computer processor, etc.) can include components for establishing communications. Examples of such a controller may be processing units alone or other subcomponents of computing devices. The intelligent control can also include other components and can be implemented partially or entirely on a semiconductor (e.g., a field-programmable gate array (“FPGA”)) chip, such as a chip developed through a register transfer level (“RTL”) design process.

In some embodiments, the control unit 206 can include a processing unit and/or multiple processing units in addition to the intelligent control. A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

One or more embodiments described herein can be implemented using programmatic modules, engines, or components. A programmatic module, engine, or component can include a program, a sub-routine, a portion of a program, or a software component or a hardware component capable of performing one or more stated tasks or functions. A module or component can exist on a hardware component independently of other modules or components. Alternatively, a module or component can be a shared element or process of other modules, programs, or machines.

Dedicated hardware implementations including, but not limited to, application specific integrated circuits, programmable logic arrays, and/or other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the methods described herein are intended for operation as software programs running on a computer processor. Furthermore, software implementations can include, but are not limited to, distributed processing and/or component/object distributed processing, parallel processing, and/or virtual machine processing.

In some embodiments, the control unit 206 can include memory. The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Nonlimiting examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the intelligent control and/or other processing unit(s), such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

In some embodiments, the control unit 206 can include an operating system and/or compiler. Generally, the non-transitory computer readable medium operates under control of an operating system stored in the memory. The non-transitory computer readable medium implements a compiler which allows a software application written in a programming language such as COBOL, C++, FORTRAN, or any other known programming language to be translated into code readable by the central processing unit. After completion, the intelligent control and/or other processing unit(s) accesses and manipulates data stored in the memory of the non-transitory computer readable medium using the relationships and logic dictated by the software application and generated using the compiler.

In at least one embodiment, the software application and the compiler are tangibly embodied in the computer-readable medium. When the instructions are read and executed by the non-transitory computer readable medium, the non-transitory computer readable medium performs the steps necessary to implement and/or use the present disclosure. A software application, operating instructions, and/or firmware (semi-permanent software programmed into read-only memory) may also be tangibly embodied in the memory and/or data communication devices, thereby making the software application a product or article of manufacture according to the present disclosure.

As shown in FIG. 7, in some embodiments, the system 200 can include a data transmitter/receiver component 208. The data transmitter/receiver component 208 can be part of the control unit 206 and can be any off-the-shelf device used for data communication, including transmitting and receiving data. Thus, the control unit 206, via the data transmitter/receiver component 208 thereof, can engage in bidirectional communication and control with the agricultural planting implement 202. Bidirectional data communication and control between the control unit 206 and the agricultural planting implement 202 allows the control unit 206 to send data to and/or control aspects of the agricultural planting implement 202 and the agricultural planting implement 202 can send data to and/or control aspects of the control unit 206. To achieve bidirectional communication/control, the agricultural implement 202, which in some embodiments is the agricultural planting implement 110 of FIG. 2, can also include a two-way data transmitter/receiver component. The control unit 206 can be used to communicate with and/or control aspects of the implement 202 including electronic components 203 on the implement 202. Such electronic components 203 can include but are not limited to any electronically driven component on the implement 202 or an aspect thereof such as but not limited to actuators; tanks; hoppers; fans; equipment associated with folding, lifting, tilting, rotating, pivoting, and/or other movements of the implement such as actuators; row units and any electrically driven element of the row unit such as meter(s), metering elements, singulation elements, fertilizer equipment, other particulate and/or liquid material application apparatus seed tank(s)/hopper(s), sensor(s), ground engaging apparatus, ground opening and/or closing elements, metering system, sensors, motors and the like.

In some embodiments, a user of the control unit 206 can input information and/or a command to the control unit 206 via touchscreen, and/or any other input method mentioned above, wherein the control unit 206 communicates said information and/or command to the agricultural implement 202. The agricultural implement 202 then receives said information and/or command and acts accordingly based on the received input information and/or command. In this way, a user can control aspects of an agricultural implement 202 via the control unit 206 and data transmitter/receiver component 208 therein. A user could input information and/or a command related to any aspect of agriculture and/or farming. For example, a user could enter information related to soil characteristics such as moisture content and/or soil temperature. The control unit 206 could then communicate that information to the agricultural implement 202 wherein the agricultural implement 202 receives said information and acts accordingly. For example, the agricultural implement 202 could adjust the height and/or downforce of components such as tilling equipment, disc rippers, row units, gauge wheels, closing wheels, and the like based on the received information. Also, a user could input a command to manually adjust aspects of the agricultural implement 202 including but not limited to the height and/or downforce of components such as tilling equipment, disc rippers, row units, gauge wheels, closing wheels, and the like. While the adjustment of the height and/or downforce of components of the agricultural implement 202 such as tilling equipment, disc rippers, row units, gauge wheels, and closing wheels is provided as an example, the control unit 206 can be used to send information related to and/or send a command related to any functionality of the agricultural implement 202 including but not limited to functionality of individual row units, or electrically driven elements thereon, and/or any other type of functionality associated with other electronic components 203 of the implement 202 such as actuators to facilitate folding, lifting, tilting, rotating, pivoting, and/or other movements of the implement. A user can communicate with and/or control each row unit, and electrically driven elements thereon, of the agricultural implement 202.

Similarly, in accordance with some embodiments, the agricultural implement 202, which in some embodiments can be the agricultural planting implement 110 of FIG. 2, can communicate data to and/or control aspects of the control unit 206. In some embodiments, the agricultural planting implement 202 can send information related to an agricultural function to the control unit 206. The control unit 206 can receive said information via the data transmitter/receiver component 208 and output/display said information via its user interface/display so that a user can read and/or otherwise interpret said information. The control unit 206 can also automatically perform a function based on the received information. For example, in some embodiments, the agricultural implement 202 could monitor information related to seed remaining in seed tanks/hoppers and communicate such information to the control unit 206 wherein the control unit 206 receives said information and displays it via the user interface/display such that a user can read and/or otherwise interpret such information. Thus, the agricultural implement 202 can control aspects of the control unit 206 in that information from the agricultural implement dictates what is displayed via the control unit 206.

In some embodiments, the communication/control system 200, including bidirectional communication and control between the control unit 206 and the agricultural implement 202, can be performed wirelessly. Wireless communication and control can include, but is not limited to Bluetooth, Wi-Fi, cellular data, radio waves, satellite, or generally any other form of wireless connection which will allow for communication between the control unit 206 and the agricultural implement 202. Therefore, the control unit 206 and agricultural implement 202 will include generally any electronic components necessary to allow for such wireless communication and control. Thus, the system 200 eliminates the need for wiring between the implement 202 and the vehicle 204 and/or the control unit 206. Wiring included on agricultural equipment can often be damaged and/or worn out due to flexing, stretching, lifting, and/or other movements. Thus, since the system 200 is wireless, the risk of data loss and/or failure due to damage and/or worn out wiring as well as wire routing issues is eliminated.

In some embodiments, the communication/control system 200 can include the use of a network. The network can be, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

The Internet Protocol (“IP”) is the principal communications protocol in the Internet protocol suite for relaying datagrams across network boundaries. Its routing function enables internetworking, and essentially establishes the Internet. IP has the task of delivering packets from the source host to the destination host solely based on the IP addresses in the packet headers. For this purpose, IP defines packet structures that encapsulate the data to be delivered. It also defines addressing methods that are used to label the datagram with source and destination information.

The Transmission Control Protocol (“TCP”) is one of the main protocols of the Internet protocol suite. It originated in the initial network implementation in which it complemented the IP. Therefore, the entire suite is commonly referred to as TCP/IP. TCP provides reliable, ordered, and error-checked delivery of a stream of octets (bytes) between applications running on hosts communicating via an IP network. Major internet applications such as the World Wide Web, email, remote administration, and file transfer rely on TCP, which is part of the Transport Layer of the TCP/IP suite.

Transport Layer Security, and its predecessor Secure Sockets Layer (“SSL/TLS”), often runs on top of TCP. SSL/TLS are cryptographic protocols designed to provide communications security over a computer network. Several versions of the protocols find widespread use in applications such as web browsing, email, instant messaging, and voice over IP (“VoIP”). Websites can use TLS to secure all communications between their servers and web browsers.

In some embodiments, the communication/control system 200 can make use of ISOBUS. ISO 11783, serial control and communications data network commonly used for tractors and machinery for agriculture and forestry (commonly referred to as “ISO Bus” or “ISOBUS”) is a communication protocol for the agriculture industry based on the SAE J1939 protocol (which includes CAN bus). The standard comes in 14 parts: ISO 11783-1: General standard for mobile data communication; ISO 11783-2: Physical layer; ISO 11783-3: Data link layer; ISO 11783-4: Network layer; ISO 11783-5: Network management; ISO 11783-6: Virtual terminal; ISO 11783-7: Implement messages application layer; ISO 11783-8: Power train messages; ISO 11783-9: Tractor ECU; ISO 11783-10: Task controller and management information system data interchange; ISO 11783-11: Mobile data element dictionary; ISO 11783-12: Diagnostics services; ISO 11783-13: File server; ISO 11783-14: Sequence control.

In some embodiments, the control unit 206 can be mounted permanently in the agricultural vehicle 204. For example, in some embodiments, the control unit 206 could be mounted in the cab 101 of the agricultural vehicle 100 of FIG. 1 such that a user could interact with the control unit 206. In some embodiments, the control unit 206 can be unmounted/mobile and/or can be handheld wherein a user can interact with the control unit 206 to remotely communicate and/or control aspects of the agricultural implement 202 to which it is operationally connected. Unmounted/mobile control units 206 can operate on the same network as mounted control unit(s) 206. In these embodiments wherein the control unit 206 is unmounted/mobile, the control unit 206 could be a tablet, phone, computer, and/or any other suitable device. Additionally, in some embodiments, a plurality of control units 206 could be included. In these embodiments, a control unit 206 could be mounted in the agricultural vehicle 204, such as the cab 101 of the agricultural vehicle 100 of FIG. 1, and one or more additional control units 206 could be mobile wherein a user could communicate with and/or control aspects of the agricultural implement 202 in a remote fashion. In these embodiments, any of the control units 206 could be used by a user to communicate with and/or control aspects of the agricultural implement 202. Also, in some embodiments, multiple control units 206 may be included wherein none are mounted in the agricultural vehicle 204 and all are mobile. In these embodiments, any of the control units 206 could be used by a user to remotely communicate with and/or control aspects of the agricultural implement 202.

In embodiments wherein one or more control units 206 are mobile such that they can be used to remotely communicate with and/or control the agricultural implement 202, some functionality can be disabled for safety reasons. For example, in some embodiments, lifting and/or pivoting of the agricultural implement can be disabled for remote control units 206. Such functionality, including lifting and/or pivoting, can be enabled for a control unit 206 mounted in the agricultural vehicle 204 and/or on the agricultural implement 202.

In some embodiments, the system 200 allows for testing and/or diagnosis of machine health functions. The system 200 allows a user, via the control unit 206, to test and/or look up the machine health of any aspect of the agricultural implement 202 to which it is operationally connected. For example, the user could test and/or look up, via the control unit 206, the health and/or status of a particular electronic component 203 such as a row unit of the agricultural implement 202. As an example, such health and/or status information could include information regarding any electrically driven element of the row unit including but not limited to seed meter(s), fertilizer equipment, seed tank(s)/hopper(s), sensor(s), ground engaging apparatus, and the like. Such health and/or status information can include any wear-and-tear and/or other damage suffered by the row unit or any component thereof, performance metrics (e.g., maximum seed dispensing rate, revolutions per minute, temperature, accuracy monitoring, camera/sensor visibility, position information, weight, fluid level, speed/acceleration data, etc.) of the row unit or any component thereof, and the like.

Additionally, the system 200 allows for diagnosis of machine health conditions. Based on the machine health and/or status information of a particular aspect and/or component of the agricultural implement 202, the system 200 can determine an issue related to said aspect and/or component and can generate a suggested course of action. The diagnosis includes both the determined issue and suggested course of action. The system 200 can communicate the determined issue and the suggested course of action to a user via the control unit 206. For example, based on the fact that seeding rate is less than expected, the system 200 can determine that the seed meter, or another component, is damaged and/or otherwise less effective/efficient than expected and communicate such information to the user via the control unit 206. In this example, the system 200 could then generate a suggested course of action, such as to inspect, repair, and/or replace the seed meter, or another component, and could communicate that suggested course of action to the user via the control unit 206.

In some embodiments, in order to allow for testing/diagnosis of machine health functions/conditions, the machine health/status of all aspects and components of the agricultural implement 202 can be continuously monitored. Sensors can be included on the implement 202 wherein the sensors monitor the machine health/status of all aspects and components of the implement 202 for testing/diagnosis purposes of machine health functions. Such sensors can include but are not limited to accelerometers, sensors to measure rate of dispensing of materials such as seed and/or fertilizer, position sensors, GPS-capable sensors, fluid level sensors, pressure sensors, weight sensors, rotational sensor, photodetectors, cameras, distance sensors, timers, temperature sensors, and the like. When a user wants to access such machine health/status information by testing and/or looking up said information and/or diagnosing machine health conditions via the control unit 206, the system 200 can communicate such information and/or diagnosis to the user via the control unit 206. In some embodiments, when a user performs a test and/or looks up machine health/status information via the control unit 206 and/or uses the control unit 206 to perform a diagnosis of machine health conditions, the system 200 can acquire such information and/or diagnosis in an on-demand fashion and communicate such information and/or diagnosis to the user.

In some embodiments, the system 200 can include the use of Linked Data. Linked Data is structured data which is interlinked with other data so it becomes more useful through semantic queries. Linked Data could be integrated into a cellular connection and/or other type of connection for data collection, machine health/status monitoring, and/or diagnosis of machine health conditions. Linked Data can also be integrated into the connection between the control unit 206 and the agricultural implement 202. Linked Data can also be integrated into a connection between the system 200, and/or any aspects thereof, and another entity such as a virtual monitor or a device such as a tablet, phone, computer, and the like. The use of Linked Data can make it easier to search and/or filter machine health/status information and/or diagnoses of machine health conditions.

In some embodiments, the system 200 can include a virtual monitor that can be accessible remotely by a tablet, phone, computer, and the like. Machine health/status information and/or diagnoses of machine health conditions related to the agricultural implement 202 can be accessible via the virtual monitor. In some embodiments, machine health/status information and/or diagnoses of machine health conditions can be sent to and received by a device, such as a tablet, phone, computer, and the like, capable of accessing the virtual monitor. The virtual monitor can display machine health/status information and/or diagnoses of machine health conditions related to the agricultural implement 202. The virtual monitor can allow a user to view and/or access the machine health/status information and/or diagnoses of machine health conditions without providing the ability for a user to control functionality of the agricultural implement 202 except for a factory/dealer override. Thus, one user who has access to the one or more control units 206 (a worker and/or farmer for example) can use the control unit(s) 206 to communicate with and/or control aspects of the agricultural implement whereas a second user who does not have access to the control unit 206 (the worker and/or farmer's supervisor/employer for example) could have access to the virtual monitor that displays the machine health/status information and/or the diagnoses of machine health conditions. The virtual monitor can operate on the same network as the control unit 206 and/or via a different network and/or communication method. For example, in some embodiments, the virtual monitor can send/receive data via WiFi.

According to some embodiments, the system 200 can use artificial intelligence (AI) in conjunction with machine health/status monitoring and/or diagnoses of machine health conditions. AI can be used to predict future machine health/status and/or predict future machine health conditions. By predicting future machine health/status and/or predicting future machine health conditions, the system 200 provides the ability for a user and/or farmer to act on such predictions such that the user and/or farmer can resolve potential issues before they happen. For example, by using AI, the system 200 can predict when a component of the agricultural implement 202 will degrade and/or deteriorate to the point that it is rendered ineffective. Such predictions can be communicated to a user and/or farmer via the control unit 206 and/or the virtual monitor. The user and/or farmer can then act on such predictions. For example, such action could include repairing and/or replacing the identified component before it degrades and/or deteriorates to the point of ineffectiveness, although other courses of action are contemplated herein. Thus, rather than the user/farmer discovering that a component of the implement 202 is ineffective while the implement 202 is performing a task, such as planting, wherein the user/farmer is forced to stop the task to repair and/or replace the component, the user/farmer is aware in advance of the component becoming ineffective wherein the user/farmer can repair, replace, and/or otherwise take action to mitigate and/or fix the issue before the implement 202 is performing a task. AI used by the system 200 in conjunction with machine health/status monitoring and/or diagnoses of machine health conditions can include the use of machine learning, deep learning, any other type of AI, and/or any combination thereof. For example, the AI model used by the system 200 can include the use of training data that includes inputs and their outputs. Inputs could include machine health/status information and/or other metrics of a component and outputs could include the amount of time until the component degrades and/or deteriorates to ineffectiveness as well as machine health conditions. In this way, the output can provide a label for the input. The AI model will be able to develop, through optimization or other techniques, a method and/or function that is used to predict the outcome of new inputs, wherein such outcomes include predictions regarding the amount of time until a component degrades and/or deteriorates, predictions of machine health conditions of the component, and the like. According to some embodiments, the AI is able to develop other models and operate in other ways.

In some embodiments, AI can be used in one or more aspects. AI is intelligence embodied by machines, such as computers and/or processors. While AI has many definitions, some have defined AI as utilizing machines and/or systems to mimic human cognitive ability such as decision-making and/or problem solving. AI has additionally been described as machines and/or systems that are capable of acting rationally such that they can discern their environment and efficiently and effectively take the necessary steps to maximize the opportunity to achieve a desired outcome. Goals of AI can include but are not limited to reasoning, problem-solving, knowledge representation, planning, learning, natural language processing, perception, motion and manipulation, social intelligence, and general intelligence. AI tools used to achieve these goals can include but are not limited to searching and optimization, logic, probabilistic methods, classification, statistical learning methods, artificial neural networks, machine learning, and deep learning.

In some embodiments, machine learning can be used in one or more aspects. Machine learning is a subset of artificial intelligence. Machine learning aims to learn or train via training data in order to improve performance of a task or set of tasks. A machine learning algorithm and/or model can be developed such that it can be trained using training data to ultimately make predictions and/or decisions. Machine learning can include different approaches such as supervised learning, unsupervised learning, semi-supervised learning, reinforcement learning, and dimensionality reduction as well as other types. Supervised learning models are trained using a training data that includes inputs and the desired output. This type of training data can be referred to as labeled data wherein the output provides a label for the input. The supervised learning model will be able to develop, through optimization or other techniques, a method and/or function that is used to predict the outcome of new inputs. Unsupervised learning models take in data that only includes inputs and engage in finding commonalities in the inputs such as grouping or clustering of aspects of the inputs. Thus, the training data for unsupervised learning does not include labeling and/or classification. Unsupervised learning models can make decisions for new data based on how alike or similar it is to existing data and/or to a desired goal. Examples of machine learning models include but are not limited to artificial neural networks, decision trees, support-vector machines, regression analysis, Bayesian networks, and genetic algorithms. Examples of potential applications of machine learning include but are not limited to image segmentation and classification, ranking, recommendation systems, visual identity tracking, face verification, and speaker verification.

In some embodiments, deep learning can be used in one or more aspects. Deep learning is a subset of machine learning that utilizes a multi-layered approach. Examples of deep learning architectures include but are not limited to deep neural networks, deep belief networks, deep reinforcement learning, recurrent neural networks, and convolutional neural networks. Examples of fields wherein deep learning can be successfully applied include but are not limited to computer vision, speech recognition, natural language processing, machine translation, bioinformatics, medical image analysis, and climate science. Deep learning models are commonly implemented as multi-layered artificial neural networks wherein each layer can be trained and/or can learn to transform particular aspects of input data into some sort of desired output.

The system 200 and/or implement 110 can use AI for any suitable functionality. Use of AI can include the use of machine learning, deep learning, any other type of AI, and/or any combination thereof. For example, according to some embodiments, the system 200 and/or implement 110 can include the use of AI for image segmentation and/or classification. For example, the system 200 and/or the planting implement 110, can include image segmentation/classification for use with ground engaging apparatus such as row cleaners. Such image segmentation/classification can be driven, conducted, facilitated, and/or assisted by the use of AI. While image segmentation/classification combined with the use of AI can be used for any suitable functionality of the system 200 and/or planter 110, as an example, such image segmentation/classification combined with AI can be used to adjust row cleaners. Row cleaners operate differently depending on a tillage condition. Different tillage techniques can be employed based on tillage condition. Some tillage techniques include intensive tillage, reduced tillage, and conservation tillage among others. Intensive tillage leaves less than 15% crop residue on the soil surface, reduced tillage leaves between 15% and 30% crop residue on the soil surface, and conservation tillage leaves at least 30% crop residue on the soil surface. Examples of conservation tillage include, but are not limited to, no-till, strip-till, mulch-till, rotational tillage, and ridge-till. According to some embodiments, image segmentation/classification can be used in combination with AI to collect image(s) of at least a portion of an agricultural field, perform image segmentation and classification on the image(s), identify tillage condition(s), and/or automatically adjust the row cleaners, and/or other apparatus used for tilling, to perform a desired tillage technique based on the image(s) and/or an identified tillage technique. According to some embodiments, AI used for image segmentation/classification can include the use of training data wherein inputs include photographs of at least a portion of an agricultural field and outputs include a tillage condition and/or desired tillage technique. The AI can develop, via optimization or other techniques, a method and/or function that is used to predict, classify, and/or assign the outcome of new inputs. The AI can continuously be monitoring and/or processing new data such that the image segmentation/classification continually improves. According to some embodiments, a user/farmer can manually control which tillage technique is used by the row cleaner(s) and/or other apparatus used for tilling.

According to some embodiments, the system 200 and/or implement 110 can include the use of AI to optimize performance of any aspects and/or components thereof in real time. This can include the use of machine learning, deep learning, any other type of AI, and/or any combination thereof. The system 200 and/or implement 110 can include ground penetrating sensors that collect data such as soil composition, soil moisture content, fertilizer levels of the soil, micro nutrient levels of the soil, and the like. AI can be used in combination with such data to actively adjust an operation of the system 200 and/or implement 110 on a row-by-row basis in real time such that the operation is optimized based on agricultural field conditions. For example, AI can be used in combination with the collected data to optimize fertilizer application, herbicide application, pesticide application, seeding rate, seed spacing, planting depth, tillage technique, and the like. According to some embodiments, AI used to optimize performance of any aspects and/or components of the system 200 and/or implement 110 can include the use of training data wherein inputs include examples of collected data referenced above such as soil composition, soil moisture content, fertilizer levels of the soil, micro nutrient levels of the soil, and the like. Outputs of the training data include the proper performance function based on the input data such as the proper fertilizer application rate and/or amount, the proper herbicide application rate and/or amount, the proper pesticide application rate and/or amount, the proper seeding rate, the proper seed spacing, the proper planting depth, the proper tillage technique, and the like. The AI can develop, via optimization and/or other techniques, a method and/or function that is used to predict, classify, assign, and/or set the outcome of new inputs. The AI can continuously be monitoring and/or processing new data such that the AI continually improves its prediction(s), classification(s), assignment(s), and/or setting of outcomes.

Additionally, according to some embodiments, the system 200 and/or implement 110 can include the use of AI to adjust and/or optimize planting depth based on a variety of factors such as seed type, soil type, soil moisture content, soil composition, fertilizer levels of the soil, micro nutrient levels of the soil, expected weather conditions, and the like. This can include the use of machine learning, deep learning, any other type of AI, and/or any combination thereof. According to some embodiments, AI can be used to analyze weather patterns and/or weather forecasts in order to generate expected weather conditions. This can include the use of training data wherein inputs include weather patterns and/or weather forecasts, and outcomes include weather conditions. The AI can develop, via optimization and/or other techniques, a method and/or function that is used to predict, classify, and/or assign, the outcome of new inputs. The AI can continuously be monitoring and/or processing new data such that the AI continually improves its prediction(s), classification(s), and/or assignment(s) of outcomes. According to some embodiments, AI can be used to adjust and/or optimize planting depth which can include the use of training data wherein inputs include examples of collected data referenced above such as seed type, soil type, soil moisture content, soil composition, fertilizer levels of the soil, micro nutrient levels of the soil, expected weather conditions, and the like. Outputs of the training data include the proper planting depth based on the input data. The AI can develop, via optimization and/or other techniques, a method and/or function that is used to predict, classify, assign, and/or set the outcome of new inputs. The AI can continuously be monitoring and/or processing new data such that the AI continually improves its prediction(s), classification(s), assignment(s), and/or setting of outputs.

In some embodiments, the system 200 and/or the implement 110 of FIG. 2 can include a satellite-based radio-navigation system such as the global positioning system (“GPS”). GPS uses satellites to provide geolocation information to a GPS receiver. GPS, and other satellite-based radio-navigation systems, can be used for location positioning, navigation, tracking, and mapping. The system 200 and/or the implement 110 can also include the use of real time kinematic positioning (RTK), which can be incorporated as part of a GPS device. The use of GPS, RTK, and/or any other satellite-based positioning system allows for highly accurate positioning data of the system 200 and agricultural implement 202, which could be agricultural implement 110 in some embodiments. In some embodiments, the system 200 and/or implement 110 can include a hub, which can be located on the agricultural implement 202, wherein the hub allows the system 200 to make use of a plurality of satellites. The plurality of satellites can be used to enable communication and/or control between the control unit 206 and the agricultural implement 202 as well as for other purposes. In some embodiments, the satellites can be located on the implement 202. The use of GPS, RTK, and/or any other satellite-based positioning system can include the use of a base station.

According to some embodiments, the communication/control system 200 can also include the use of at least one intelligent planter router/intelligent implement router IPR/IIR, at least one intelligent planter node/intelligent implement node (IPN/IIN), and at least one intelligent planter positioning/intelligent implement positioning (IPP/IIP). The IPR/IIR, IPN/IIN, and IPP/IIP, may be that which is disclosed in U.S. Pat. No. 10,952,365 which is hereby incorporated in its entirety. All child U.S. patent applications and U.S. patents originating from U.S. Pat. No. 10,952,365 are also hereby incorporated in their entirety. According to some aspects, the communication/control system 200 disclosed herein may utilize the at least one IPR/IIR, IPN/IIN, IPP/IIP, and/or other aspects of the implement control system of U.S. Pat. No. 10,952,365 and all child U.S. patent Applications and U.S. patents resulting from U.S. Pat. No. 10,952,365. For example, the implement control system can be adapted to perform the functions of the communication/control system 200 disclosed herein. The communication/control system 200 can use at least one IPR/IIR, IPN/IIN, and/or IPP/IIP to perform wireless, bidirectional, and/or remote communication and/or control between the control unit 206 and the implement 202. The communication/control system 200 can use any and/or all aspects of the implement control system of U.S. Pat. No. 10,952,365 wherein use of such components is wireless rather than using Ethernet or any other wired connection.

According to some embodiments, the implement control system of U.S. Pat. No. 10,952,365 may be adapted to detect, sense, monitor, and/or perform functionality related to machine health/status information and/or diagnoses of machine health conditions. For example, one or more IPPs/IIPs, IPNs/IINs, and/or IPRs/IIRs can be used to monitor, detect, and/or sense machine health/status information and/or diagnoses of machine health conditions and to communicate such information and conditions to the control unit 206 and/or the virtual monitor.

According to some embodiments, the communication/control system 200 does not include an IPR/IIR, an IPN/IIN, or an IPP/IIP.

In some embodiments, to improve communication and/or control between the control unit 206 and agricultural implement 202, each row unit of the agricultural implement 202 can include a unique identifier. Thus, the system 200 is able to communicate with individual row units based on its unique identifier. The unique identifier of each row unit allows for better communication/control of each row unit of the agricultural implement 202. The unique identifier also allows for improved machine health/status monitoring and/or diagnoses of machine health conditions. The unique identifier enhances the modularity of the row units.

In some embodiments, the system 200 is capable of connecting to agricultural equipment other than a planting implement. The system 200 can connect to any agricultural implement and/or agricultural equipment including but not limited to a planter, fertilizer, sprayer, plow, combine, spreader, ripper, cart, seed tender, and the like. In other words, the implement 202 of the system 200 can be any sort of agricultural implement and/or agricultural equipment. Thus, the control unit 206 of the system 200 can be used to bidirectionally communicate with and/or control any kind of agricultural implement and/or agricultural equipment.

According to some embodiments, the system 200, and control unit 206 thereof, can include a cloud-based data management system wherein data can be saved remotely using cloud technology such that it is not saved directly on the control unit 206. This cloud-based data management system provides the ability to sync mapping information and to share other data wherein multiple planters can coordinate planting of a single agricultural field and/or multiple agricultural fields. In this way, multiple planters can share coverage data. This map sync feature and cloud-based data management system may be that which is disclosed in U.S. Provisional Patent Application No. 63/267,865. Since the cloud-based data management system provides storage of data at a remote location, it ensures that data is backed-up and saved wherein it can be pulled down to one or multiple control units 206 at any time so that such data can be utilized. The cloud-based data management system can be used to connect other agricultural equipment in addition to planters such as vehicles, fertilizers, sprayers, plows, combines, spreaders, rippers, carts, seed tenders, and the like.

In some embodiments, the system 200 can include a combination of wired and wireless components. In these embodiments, a router may be included wherein satellites used for communication are wired to the row units of the implement 202.

As understood from the present disclosure, the all electrical planting implement provides the ability to power an agricultural implement without the use of hydraulic power and/or any hydraulic plumbing including but not limited to hoses, fittings, valves, hydraulic radiators, and the like. This greatly reduces and/or eliminates the cost, time, and effort associated with installation, repair, maintenance, and/or replacement of such plumbing. The all electrical planting implement also allows for minimal/no agricultural vehicle PTO valve requirements. Rather, aspects of the all electrical implement can plug directly into the PTO of the agricultural vehicle to which the all electrical implement is attached. This allows the all electrical implement to be powered easily while eliminating the cost, time, and effort spent on installation, repair, maintenance, and/or replacement of such valve(s). The all electrical planting implement also improves efficiency and resource conservation by increasing the fuel efficiency of an attached agricultural vehicle and mitigating energy loss that existed in the prior art due to heat buildup caused by hydraulic radiators during hydraulic operation. The all electrical planting implement also provides for row units of an agricultural implement to be modular in that they can operate on a plug-and-play basis. The all electrical planting implement also provides the ability to quickly swap out row units, and/or components thereof, to minimize downtime. The all electrical planter also eliminates the need for pneumatic system(s), and components thereof, for particular functionality of the planter, such as downforce. This greatly reduces and/or eliminates the time, effort, and money needed to monitor, maintain, repair, replace, and/or resolve issues related to components of a pneumatic system, which are prone to degrade, deteriorate, and/or leak.

As understood from the present disclosure, the communication/control system provides for bidirectional communication and control that is wireless and has remote capabilities. Thus, a wireless communication/control system can be used rather than a wired system. Wired systems used on agricultural implements, including for lifting and/or pivoting, often wear out and/or are damaged due to repeated bending, flexing, stretching, and other motions. Additionally, the communication/control system eliminates the need for any other wired portions connecting an agricultural implement and an agricultural vehicle. Further, the wireless system eliminates the need for wire loom on man-lifts. Thus, the wireless communication/control system eliminates the cost, time, and effort needed for installation, repair, maintenance, and/or replacement of wires/cables in a wired system. Also, because no wires are used for communication between the agricultural implement and an agricultural vehicle and/or control unit, there is no risk of data loss and/or failure due to damage to the wires or routing issues. Additionally, the wireless communication/control system provided herein could be used to retrofit previously wired systems on agricultural implements. The communication/control system also allows communication/control to occur remotely via the use of a mobile device such as a tablet, phone, computer, and the like. This allows a user to save valuable time and effort due to not requiring the user to be in, on, and/or near the agricultural implement and/or agricultural vehicle in order to communicate with and/or control the agricultural implement.

1. An electrically operated agricultural planting implement, comprising:
one or more electronic components associated with the implement and configured to perform at least one agricultural function;
a generator to generate electric power and supply said electric power to the one or more electronic components;
wherein the electric power is used to power the one or more electronic components, and the implement and components are operated without the need for hydraulic connection between the implement and a tow vehicle.

2. The agricultural planting implement of claim 1, further comprising one or more row units that each comprises an electronic seed metering system for metering and delivering seed to the ground.

3. The agricultural planting implement of claim 1, further comprising an electrical distribution box to receive the electric power generated by the generator.

4. The agricultural planting implement of claim 1, wherein the generator is operatively connected to and driven by a power take-off of the agricultural vehicle.

5. The agricultural planting implement of claim 4, wherein the generator is configured to provide voltage conversion to step up and/or step down a voltage level provided by the power take-off of the agricultural vehicle.

6. The agricultural planting implement of claim 1, further comprising a toolbar wherein the toolbar comprises a busbar.

7. The agricultural planting implement of claim 6, wherein each of the one or more electronic components comprises a conductive portion and is operatively connected to the busbar via the conductive portion.

8. The agricultural planting implement of claim 6, wherein a portion of the toolbar further comprises a row unit and the one or more electronic components comprise at least one electrically driven element located on the row unit.

9. The agricultural planting implement of claim 8, wherein a portion of the toolbar comprises a conductor wherein the row unit comprises a conductive portion for contacting the conductor of the toolbar.

10. The agricultural implement of claim 9, further comprising a securing mechanism to hold the row unit in place and in contact with the toolbar to conduct the electric power from the toolbar to the row unit.

11. The agricultural implement of claim 2, wherein the one or more row units are modular, and each comprises at least one electrically driven element such that the at least one electrically driven element thereon can be controlled independently of other electrically driven elements, other electronic components, and/or other row units.

12. A data communication and control system for use with an agricultural planting implement and an agricultural vehicle, comprising:
one or more electronic components configured to perform at least one agricultural function; and
a control unit configured to allow for bidirectional data communication and control between the control unit and the agricultural planting implement;
wherein the data communication and control between the control unit and the agricultural planting implement is performed via a wireless connection; and
wherein the control unit is capable of being remote from the agricultural planting implement and the agricultural vehicle such that it is not mounted on the agricultural implement or the agricultural vehicle.

13. The data communication and control system of claim 12, wherein the control unit comprises a two-way data transmitter/receiver component to enable the bidirectional data communication and control.

14. The data communication and control system of claim 12, wherein the wireless connection is a WiFi connection.

15. The data communication and control system of claim 12, wherein the wireless connection is a cellular connection.

16. The data communication and control system of claim 15, wherein linked data is integrated into the cellular connection.

17. The data communication system of claim 12, wherein the control unit comprises a user interface such that the user can control/operate aspects of the agricultural planting implement by providing input to the control unit, and wherein the control unit provides output such that the user can view and interpret said output.

18. The data communication system of claim 12, wherein the control unit comprises one or more control units wherein the one or more control units are mobile devices such that the user can remotely control/operate the agricultural planting implement via the one or more control units.

19. The data communication system of claim 12, wherein the system provides machine health/status monitoring and/or allows for diagnosis of machine health conditions.

20. The data communication system of claim 19, wherein the machine health/status information and/or the diagnosis of machine health conditions is viewable on a virtual monitor wherein a user does not have access to functionality of the agricultural planting implement.

21. An agricultural system for use with an agricultural planting implement and an agricultural vehicle, comprising:
one or more row units located on the agricultural planting implement wherein each of the one or more row units comprises one or more electrically driven elements configured to perform at least one agricultural function;
a generator to generate electric power and supply said electric power to the agricultural planting implement;
wherein the electric power is used to power the one or more electrically driven elements and the implement and elements are operated without the need for hydraulic connection between the implement and a tow vehicle.

22. A method of supplying power to an agricultural planting implement, comprising:
generating electric power via a generator;
supplying the electric power to the agricultural planting implement wherein the agricultural planting implement comprises one or more electronic components;
wherein the electric power is used to power the one or more electronic components and the implement and components are operated without the need for hydraulic plumbing between the implement and a tow vehicle.

23. The method of claim 22, further comprising stepping down and/or stepping up the voltage level of the electric power before supplying the electric power to the one or more electronic components.

24. The method of claim 22, wherein the agricultural planting implement comprises a toolbar and the toolbar comprises a busbar.

25. The method of claim 24, further comprising securing a row unit to the toolbar via a securing mechanism wherein a conductive portion of the row unit is in contact with the busbar and/or a conductor of the busbar.

26. The method of claim 24, wherein supplying the electric power to the one or more electronic components comprises operationally connecting the one or more electronic components to the busbar.

27. The method of claim 22, wherein the power source to the generator is a power take-off of the tow vehicle.

28. The method of claim 22, wherein the agricultural planting implement comprises one or more row units that are modular and wherein each of the one or more row units comprises at least one electrically driven element such that the at least one electrically driven element can be controlled independently of other electrically driven elements, other electronic components, and/or other row units.

29. A method of communicating data and controlling functionality associated with agricultural planting for use with an agricultural planting implement and an agricultural vehicle, comprising:
wirelessly connecting a control unit and one or more electronic components wherein each of the one or more electronic components is located on the agricultural planting implement;
wherein the wireless connection between the one or more electronic components and the control unit allows for bidirectional data communication and control; and
wherein the control unit is capable of being remote from the agricultural planting implement and the agricultural vehicle such that it is not mounted on the agricultural planting implement or the agricultural vehicle.

30. The method of claim 29, wherein the control unit comprises a user interface such that a user can control/operate aspects of the agricultural planting implement by providing input to the control unit, and wherein the control unit provides output such that the user can view and interpret said output.

31. The method of claim 29, wherein the control unit comprises one or more control units wherein the one or more control units are mobile devices such that the user can remotely control/operate the agricultural planting implement via the one or more control units.

32. The method of claim 30, further comprising outputting machine health/status monitoring and/or allows for diagnosis of machine health conditions via the user interface.

33. The method of claim 29, further comprising outputting machine health/status information and/or diagnosis of machine health conditions on a virtual monitor accessible on a device other than the control unit.
